(19) United States
(12) Patent Application Publication
(10) Pub. No.: US 2024/0172326 A1
(43) Pub. Date: May 23, 2024

(54) TRANSMISSION METHOD, APPARATUS, AND DEVICE, AND MEDIUM

(71) Applicant: VIVO MOBILE COMMUNICATION CO., LTD., Dongguan (CN)

(72) Inventors: Siqi LIU, Dongguan (CN); Zichao JI, Dongguan (CN); Huan WANG, Dongguan (CN)

(73) Assignee: VIVO MOBILE COMMUNICATION CO., LTD., Dongguan (CN)

(21) Appl. No.: 18/393,660

(22) Filed: Dec. 21, 2023

Related U.S. Application Data
(63) Continuation of application No. PCT/CN2022/102272, filed on Jun. 29, 2022.

(30) Foreign Application Priority Data
Jun. 29, 2021 (CN) 202110726806.9

(51) Int. Cl. H04W 76/30; H04W 28/26; H04W 72/566; H04W 92/18

(52) U.S. Cl. CPC H04W 76/30; H04W 28/26; H04W 72/566; H04W 92/18

(57) ABSTRACT

A transmission method, a transmission device, and a non-transitory computer readable storage medium are provided. The transmission method includes: determining, by a first device, a target limit of first User Equipment (UE); and dropping, by the first device, first transmission when transmission of a target transmission object that needs to be performed by the first UE exceeds the target limit. The first transmission is at least a part of the transmission of the target transmission object. The transmission of the target transmission object is Sidelink (SL) transmission. The target limit includes at least one of the following: a target transmission limit or a target time limit. The first device includes at least one of the following: the first UE, a second UE, or a control node. The second UE is a UE related to sidelink transmission of the first UE.

### CROSS-REFERENCE TO RELATED APPLICATIONS

This application is a continuation of International Application No. PCT/CN2022/102272, filed on Jun. 29, 2022, which claims priority to Chinese Patent Application No. 202110726806.9, filed on Jun. 29, 2021. The entire contents of each of the above-referenced applications are expressly incorporated herein by reference.

### TECHNICAL FIELD

This application relates to the field of communication technologies, and specifically relates to a transmission method, apparatus, and device, and a medium.

### BACKGROUND

Currently, a bandwidth of a single carrier and a transmission rate and a throughput that can be provided in a Sidelink (SL) technology are limited, and requirements of some high-rate services cannot be met. Therefore, Carrier Aggregation (CA) is supported on a sidelink to meet the following requirement of the high-rate services. However, a User Equipment (UE) is required to support SL transmission on a plurality of Component Carrier (CC) at the same time, which may exceed a transmission limit corresponding to the UE, and consequently, normal SL transmission cannot be performed.

### SUMMARY

Embodiments of this application provide a transmission method and apparatus, UE, and a medium.

According to a first aspect, a transmission method is provided, including, determining, by a first device, a target limit of first UE, and dropping, by the first device, first transmission if transmission of a target transmission object that needs to be performed by the first UE exceeds the target limit, where the first transmission is at least a part of the transmission of the target transmission object; the transmission of the target transmission object is SL transmission; the target limit includes at least one of the following: a target transmission limit and a target time limit; the first device includes at least one of the following: the first UE, second UE, and a control node; and the second UE is UE related to sidelink transmission of the first UE.

According to a second aspect, a transmission apparatus is provided, including: a determining module, configured to determine a target limit of first UE; and an execution module, configured to drop first transmission if transmission of a target transmission object that needs to be performed by the first UE exceeds the target limit, where the first transmission is at least a part of the transmission of the target transmission object; the transmission of the target transmission object is SL transmission; and the target limit includes at least one of the following: a target transmission limit and a target time limit.

According to a third aspect, a transmission device is provided, including a processor, a memory, and a program or an instruction that is stored in the memory and that can be run on the processor, where the program or the instruction is executed by the processor to implement the steps of the method in the first aspect.

According to a fourth aspect, a transmission device is provided, including a processor and a communication interface, where the processor is configured to: determine a target limit of first UE; and drop first transmission if transmission of a target transmission object that needs to be performed by the first UE exceeds the target limit, where the first transmission is at least a part of the transmission of the target transmission object; the transmission of the target transmission object is SL transmission; the target limit includes at least one of the following: a target transmission limit and a target time limit; the transmission device includes at least one of the following, the first UE, second UE, and a control node; and the second UE is LIE related to sidelink transmission of the first UE.

According to a fifth aspect, a readable storage medium is provided, where a program or an instruction is stored on the readable storage medium, and the program or the instruction is executed by a processor to implement the steps of the method in the first aspect.

According to a sixth aspect, a chip is provided. The chip includes a processor and a communication interface, the communication interface is coupled to the processor, and the processor is configured to run a program or an instruction to implement the method in the first aspect.

According to a seventh aspect, a computer program/program product is provided. The computer program/program product is stored in a storage medium, and the program/program product is executed by at least one processor to implement the steps of the method in the first aspect.

In the embodiments of this application, a first device determines a target limit of first UE and drops first transmission in a case that transmission of a target transmission object that needs to be performed by the first UIE exceeds the target limit, where the first transmission is at least a part of the transmission of the target transmission object, the target limit includes at least one of the following a target transmission limit and a target time limit, and the transmission of the target transmission object is SL transmission. After the first device drops the first transmission, it can be ensured that the target limit is not exceeded when the first UE transmits the target transmission object, thereby ensuring that the first UE can normally perform SL transmission.

### BRIEF DESCRIPTION OF DRAWINGS

FIG. 1 is a schematic structural diagram of a communication system according to an embodiment of this application;

FIG. 2 is a first schematic diagram of a transmission scenario according to an embodiment of the present application;

FIG. 3 is a second schematic diagram of a transmission scenario according to an embodiment of the present application;

FIG. 4 is a third schematic diagram of a transmission scenario according to an embodiment of the present application;

FIG. 5 is a fourth schematic diagram of a transmission scenario according to an embodiment of the present application;

FIG. 6 is a schematic flowchart of a transmission method according to an embodiment of the present application:

FIG. 7 is a fifth schematic diagram of a transmission scenario according to an embodiment of the present application;

FIG. 8 is a sixth schematic diagram of a transmission scenario according to an embodiment of the present application;

FIG. 9 is a seventh schematic diagram of a transmission scenario according to an embodiment of the present application;

FIG. 10 is an eighth schematic diagram of a transmission scenario according to an embodiment of the present application;

FIG. 11 is a schematic structural diagram of a transmission apparatus according to an embodiment of the present application;

FIG. 12 is a schematic structural diagram of a communication device according to an embodiment of the present application; and

FIG. 13 is a schematic structural diagram of a terminal according to an embodiment of the present application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

In the specification and claims of this application, the terms “first”, “second”, and the like are intended to distinguish between similar objects but do not describe a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. The following descriptions describe a New Radio (NR) system for example purposes, and NR terms are used in most of the following descriptions, but these technologies can also be applied to an application other than an NR system application, for example, a 6^{th} Generation (6G) communication system.

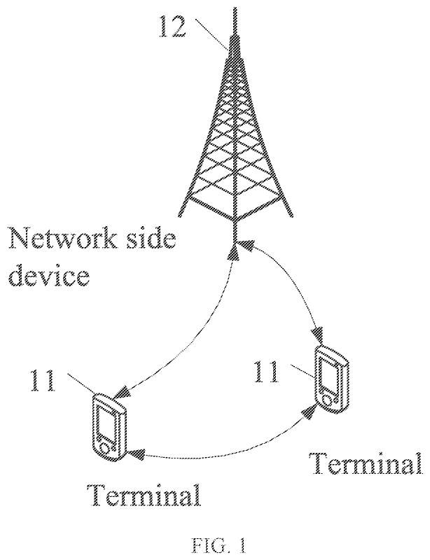

FIG. 1 is a block diagram of a wireless communication system to which embodiments of this application can be applied. The wireless communication system includes a terminal 11 and a network side device 12.

A device that has a scheduling capability or a control capability is collectively referred to as a control node. For example, the control node may be UE or a network side device, for example, at least one of an NR base station, an ITE base station, an RSU, scheduling UE, header UE, and a header vehicle.

The terminal 11 may also be referred to as a terminal device or a user terminal. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MTD), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or furniture), and the wearable device includes a smart watch, a smart band, a smart headset, smart glasses, smart jewelry (a smart bracelet, a smart chain bracelet, a smart ring, a smart necklace, a smart anklet, a smart ankle chain, and the like, a smart wrist strap, smart clothing, a game consoles, and the like. It should be noted that a specific type of the terminal 11 is not limited in the embodiments of this application. The network side device may be a base station or a core network. The base station may be referred to as a NodeB, an evolved NodeB, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a WLAN access point, a Wi-Fi node, a Transmission and Reception Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

With reference to the accompanying drawings, a transmission method provided in the embodiments of this application is described in detail by using some embodiments and application scenarios.

Currently, a bandwidth of a single carrier and a transmission rate and a throughput that can be provided in a sidelink technology are limited, and requirements of some high-rate services cannot be met. Therefore. CA is supported on a sidelink to meet the following requirement of the high-rate services. However, that UE may perform receiving at the same time (the receiving may include measurement, or in other words, the UE may perform measurement at the same time) or sending at the same time subjects to specific limits, and therefore both the UE itself and a control node need to ensure that a corresponding limit is not exceeded when actually performing receiving or sending. For example:

Scenario 1. There are a plurality of transmission limits at the same time or within a preset time range.

Case 1 is a scenario in which a Transmit (TX) limit is greater than a Receive (RX) limit.

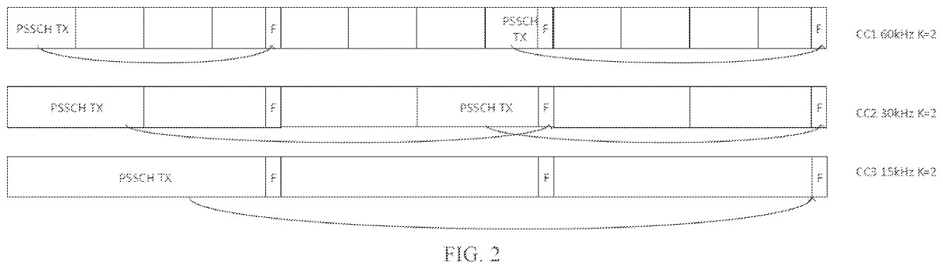

In this scenario, it is assumed that the UE can support sending at the same time on three carriers and can support receiving at the same time on two carriers Referring to FIG. 2, if the UE separately sends Physical Sidelink Share Channels (PSSCHs) on three carriers, it can be learned that the UE can send the PSSCHs on the three carriers and/or CCs at the same time. If feedback Physical Sidelink Feedback Channels (PSFCHs) corresponding to three PSSCHs are located at the same time, it means that the UE needs to receive the PSFCHs on the three carriers at the same time, which exceeds a receive limit or a receive capability of the UE. This needs to be avoided by means of reasonable resource selection/scheduling.

Case 2 is a Case of TX Limit=RX Limit.

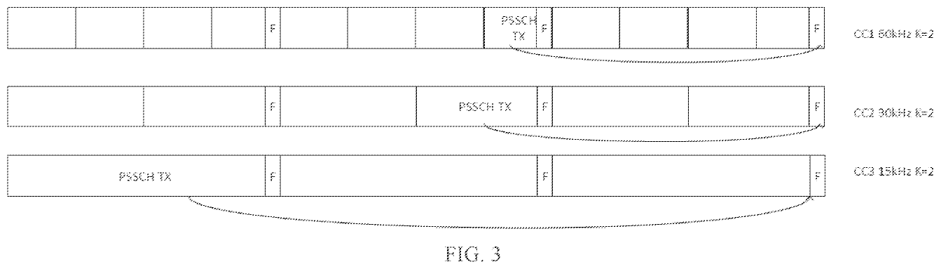

In this scenario, it is assumed that the UE can support sending at the same time on two carriers and can support receiving at the same time on two carriers. Referring to FIG. 3, if the UE separately sends three PSSCHs on three carriers, and only two PSSCHs are sent at the same time, which does not exceed a transmit capability of the UE. However, if feedback PSFCHs corresponding to the three PSSCHs are located at the same time, it means that the UE needs to receive the PSFCHs on the three carriers at the same time, which exceeds a receive limit or a receive capability of the UE. This needs to be avoided by means of reasonable resource selection/scheduling.

Case 3 is a Case of TX Limit<RX Limit.

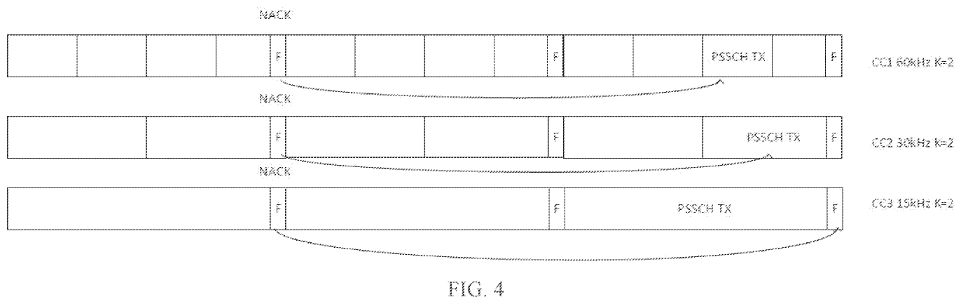

In this scenario, it is assumed that the UE can support sending at the same time on two carriers and can support receiving at the same time on three carriers. Referring to FIG. 4, if the UE receives NACKs on PSFCHs of three carriers at the same time, the UE needs to separately perform corresponding PSSCH retransmission on the three carriers. If three selected retransmission resources are overlapped in time domain, a transmit limit of the UE is exceeded, and consequently normal retransmission cannot be performed.

In general, since there are association relationships between TX and RX in some cases, one party does not exceed a corresponding limit, but the associated other party may exceed the corresponding limit.

Scenario 2: Limit Caused by a Processing Time.

Generally, a capability of the UE further includes a time limit such as a processing delay. If transmission fails to meet a requirement of the processing delay, normal transmission still cannot be performed. It is assumed that the UE can support sending on one carrier at the same time or within a preset range. Referring to FIG. 5, it is assumed that the UE sends a PSSCH on a carrier and/or CC #1, then sends a PSSCH on a carrier and/or CC #2, and then returns to the carrier and/or CC #1 to send a PSSCH. Although the two PSSCHs are not sent at the same time, if an interval between the two PSSCHs is less than a processing time required by the UE for switching a carrier, normal transmission cannot be performed.

The embodiments of this application provide a transmission method, apparatus, and device, and a medium. A target limit of first UE in SL transmission is defined, so that a first device determines the target limit of the first UE and drops first transmission in a case that transmission of a target transmission object that needs to be performed by the first UE exceeds the target limit, where the first transmission is at least a part of the transmission of the target transmission object. After the first device drops the first transmission, it can be ensured that the target limit is not exceeded when the first UE transmits the target transmission object, that is, it is ensured that the corresponding target limit is not exceeded when the first UE actually performs receiving/sending, thereby ensuring that the first UE can normally perform SL transmission.

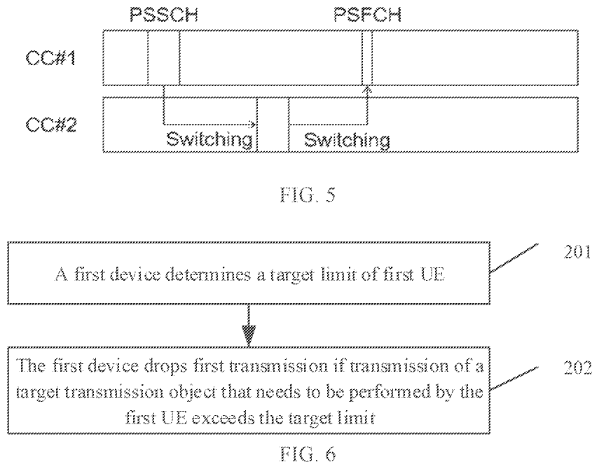

An embodiment of this application provides a transmission method. As shown in FIG. 6, the transmission method may include the following steps:

Step 201: A first device determines a target limit of first UE.

Step 202: The first device drops first transmission if transmission of a target transmission object that needs to be performed by the first UE exceeds the target limit.

The first transmission is at least a part of the transmission of the target transmission object.

The transmission of the target transmission object is SL transmission (including SL sending and/or SL receiving). The first device includes the first UE and/or second UE, and the second UE is UE related to sidelink transmission of the first UE.

It should be noted that the receiving in this application may include measurement. That is, the foregoing SL receiving includes SL measurement.

It should be noted that the “dropping first transmission” in this application may be invalidating the first transmission, discarding the first transmission, or the like. In addition, the “dropping first transmission” in this specification may be considered as reserving transmission other than the first transmission.

In this embodiment of this application, the target transmission object includes a target channel or a target signal. Further, the target channel includes at least one of the following: a Physical Sidelink Control Channel (PSCCH), a PSSCH, a PSFCH, a Sidelink Secondary Synchronization Signal (S-SSS), a Sidelink Primary Synchronization Signal (S-PSS), and a Physical Sidelink Broadcast Channel (PSBCH). The target signal may be a reference signal. It should be noted that if all the mentioned signals and/or channel types are included, that is, the target limit is a limit on any SL.

For example, in this embodiment of this application, after determining the target limit of the first UE, the first device determines a transmission manner in which the first UE transmits a specific transmission object (for example, a specific signal or channel), so that the target limit of the first UE can be noted exceeded when the first UE transmits the specific transmission object in the foregoing transmission manner.

In this embodiment of this application, the target limit includes at least one of the following a target transmission limit and a target time limit. The target transmission limit includes any one of the following: a target receive limit, a target transmit limit, and a target transmit and receive limit.

In this embodiment of this application, the target transmission limit includes at least one of the following:
a quantity N1 of transmit antennas;
a quantity N2 of receive antennas;
a quantity N3 of transmit antennas and receive antennas;
a quantity N4 of transmit chains;
a quantity N5 of receive chains;
a quantity N6 of transmit chains and receive chains;
a maximum quantity of bearer objects for receiving and/or sending target transmission objects at the same time or within a first preset time;
a maximum quantity of target transmission objects received and/or sent at the same time or within a second preset time; and
a maximum quantity of target transmission objects received and/or sent at the same time or within a third preset time on X bearer objects.

In a possible example, the target receive limit includes at least one of the following:
a quantity N2 of receive antennas; a quantity N3 of transmit antennas and receive antennas; a quantity N5 of receive chains; a quantity N6 of transmit chains and receive chains; a maximum quantity of carriers and/or CCs or cells for receiving target transmission objects at the same time or within a preset time 1 (for example, if UE receives target transmission objects on a maximum of two carriers and/or CCs at the same time or within the preset time 1, a receive limit is two carriers and/or CCs), a maximum quantity of BWPs for receiving target transmission objects at the same time or within a predetermined time 2; a maximum quantity of target transmission objects received at the same time or within a predetermined time 3; a maximum quantity of resource pools for receiving target transmission objects at the same time or within a predetermined time 4; a maximum quantity of target transmission objects received on X1 carriers or CCs or cells at the same time or within a predetermined time 5; a maximum quantity of target transmission objects received on X2 BWPs at the same time or within a predetermined time 6; and a maximum quantity of target transmission objects received on X3 resource pools at the same time or within a predetermined time 7.

In a possible example, the target transmit limit includes at least one of the following:
a quantity N1 of transmit antennas; a quantity N3 of transmit antennas and receive antennas; a quantity N4 of transmit chains; a quantity N6 of transmit chains and receive chains; a maximum quantity of carriers or CCs or cells for sending target transmission objects at the same time or within a preset time 8 (for example, if UE sends target transmission objects on a maximum of two carriers and/or CCs at the same time or within the preset time 8, a transmit limit is two carriers and/or CCs); a maximum quantity of BWPs for sending target transmission objects at the same time or within a predetermined time 9; a maximum quantity of target transmission objects sent at the same time or within a predetermined time 10; a maximum quantity of resource pools for sending target transmission objects at the same time or within a predetermined time 11; a maximum quantity of target transmission objects sent on X4 carriers or CCs or cells at the same time or within a predetermined time 12; a maximum quantity of target transmission objects sent on X5 BWPs at the same time or within a predetermined time 13; and a maximum quantity of target transmission objects sent on X6 resource pools at the same time or within a predetermined time 14.

In a possible example, the target transmit and receive limit includes at least one of the following:
a quantity N1 of transmit antennas; a quantity N2 of receive antennas, a quantity N3 of transmit antennas and receive antennas; a quantity N4 of transmit chains; a quantity N5 of receive chains; a quantity N6 of transmit chains and receive chains; a maximum quantity of carriers or CCs or cells for receiving and sending target transmission objects at the same time or within a preset time 15 (for example, if UE receives and sends target transmission objects on a maximum of two carriers and/or CCs at the same time or within the preset time 15, a transmit and receive limit is two carriers and/or CCs); a maximum quantity of BWPs for receiving and sending target transmission objects at the same time or within a predetermined time 16, a maximum quantity of target transmission objects received and sent at the same time or within a predetermined time 17; a maximum quantity of resource pools for receiving and sending target transmission objects at the same time or within a predetermined time 18; a maximum quantity of target transmission objects received and sent on X7 carriers or CCs or cells at the same time or within a predetermined time 19; a maximum quantity of target transmission objects received and sent on X8 BWPs at the same time or within a predetermined time 20; and a maximum quantity of target transmission objects received and sent on X9 resource pools at the same time or within a predetermined time 21.

It should be noted that the first preset time, the second predetermined time, the third predetermined time, and a value of X may be flexibly set according to a specific limit, and predetermined times in different limits are different.

In this embodiment of this application, the bearer object includes at least one of the following: a carrier, a CC, a cell, a BWP, and a resource pool.

In this embodiment of this application, the target time limit includes at least one of the following:
a minimum time limit for switching a bearer object;
a maximum time limit for switching a bearer object;
a minimum time limit for power adjustment;
a maximum time limit for power adjustment;
a minimum time limit for adjusting a transmission chain;
a maximum time limit for adjusting a transmission chain;
a time limit for preparing the target transmission object (for example, a preparation time of a PSFCH, a preparation time of a PSCCH, a preparation time of a PSSCH, and a preparation time of retransmission);
a time limit for preparing candidate resource reporting; and
a time limit required for determining a candidate resource, where
the transmission chain includes a transmit chain and/or a receive chain.

The time limit for switching a bearer object may be referred to as Tfreqswitchinglimit, the time limit for power adjustment may be referred to as Tpowerlimit, and the time limit for adjusting a transmission chain may be referred to as Trf limit.

The target time limit may be represented by Tswitch limit actual or Tswitch limit.

In an example, the minimum time limit for adjusting a transmission chain includes at least one of the following:
a time limit for transmission conversion (which may be referred to as Tretuning limit),
a minimum time limit for switching from sending to receiving (which may be referred to as Ttx-rx limit);
a minimum time limit for switching from receiving to sending (which may be referred to as Trx-tx limit);
a minimum time limit for switching from sending to receiving and then to sending (which may be referred to as Ttx-rx-tx limit); and
a minimum time limit for switching from receiving to sending and then to receiving (which may be referred to as Trx-tx-rx limit); and
the maximum time limit for adjusting a radio frequency chain includes at least one of the following:
a time limit for transmission conversion (which may be referred to as Tretuning limit);
a maximum time limit for switching from sending to receiving (which may be referred to as Ttx-rx limit);
a maximum time limit for switching from receiving to sending (which may be referred to as Trx-x limit);
a maximum time limit for switching from sending to receiving and then to sending (which may be referred to as Ttx-rx-tx limit); and
a maximum time limit for switching from receiving to sending and then to receiving (which may be referred to as Trx-tx-rx limit).

For example, in this embodiment of this application, different target transmission objects respectively have corresponding target limits, and/or the target limit is related to a frequency domain.

Further, in this embodiment of this application, the frequency domain may be a band or a band combination or an Frequency Range (FR).

Further, in this embodiment of this application, that the target limit is related to a frequency domain includes at least one of the following transmission on a plurality of bearer objects at the same time or within a fourth preset time is supported only in a target frequency domain; and different frequency domains respectively have corresponding target limits.

For example, transmission on a plurality of bearer objects (for example, at least one of a carrier, a CC, a cell, a BWP/resource pool, and an RF chain) at the same time or within a preset time range is supported only in a specific band/or a specific band combination and/or a specific FR.

For example, different frequency domains have respective corresponding first limits and/or actual limits, and the first limits and/or actual limits corresponding to the different frequency domains may be different.

For example, in this embodiment of this application, the target limit is determined based on at least one of the following:
a UE capability of the first UE;
a limit configured by the control node;
a limit indicated by another UE;
a preconfigured limit; and
a limit predefined in a protocol.

Further, a minimum value or a maximum value of the limit in the foregoing at least two items may be determined as the target limit.

Further, the UE capability includes the target limit.

Further, the UE may report the target limit to the control node, another UE, or another device.

For example, in this embodiment of this application, the target limit includes an actual limit and/or a first limit of the first UE.

Further, in this embodiment of this application, the first limit includes a first transmission limit; the actual limit includes an actual transmission limit, and the target transmission limit includes the first transmission limit and/or the actual transmission limit, where the first transmission limit includes at least one of the following: a first receive limit (which may be referred to as RX limit), a first transmit limit (which may be referred to as TX limit), and a first transmit and receive limit (which may be referred to as total limit); and the actual transmission limit includes at least one of the following: an actual receive limit (which may be referred to as total limit actual), an actual transmit limit (which may be referred to as TX limit actual), and an actual transmit and receive limit (which may be referred to as RX limit actual).

In an embodiment, it is guaranteed and/or assumed that TX limit≥RX limit, and/or TX limit actual≥RX limit actual.

It can be understood that a relationship is met between the transmission limits in this embodiment of this application, and the relationship is compatible with an association relationship between receiving and sending. In this way, a case that a plurality of transmissions exceed the target limit can be avoided in a case that there is an association relationship between receiving and sending.

In a possible implementation, the actual transmission limit includes at least one of the following:
a quantity M1 of transmit antennas;
a quantity M2 of receive antennas;
a quantity M3 of transmit antennas and receive antennas;
a quantity M4 of transmit chains;
a quantity M5 of receive chains;
a quantity M6 of transmit chains and receive chains;
a maximum quantity of bearer objects for actually receiving and/or sending target transmission objects at the same time or within a first preset time;
a maximum quantity of target transmission objects actually received and/or sent at the same time or within a second preset time; and
a maximum quantity of target transmission objects actually received and/or sent at the same time or within a third preset time on X bearer objects.

In a possible example, the actual receive limit includes at least one of the following:
a quantity M1 of transmit antennas; a quantity M2 of receive antennas; a quantity M3 of transmit antennas and receive antennas, a quantity M4 of transmit chains; a quantity M5 of receive chains; a quantity M6 of transmit chains and receive chains; a maximum quantity of carriers or CCs or cells for actually receiving target transmission objects at the same time or within a preset time 1; a maximum quantity of BWPs for actually receiving target transmission objects at the same time or within a predetermined time 2; a maximum quantity of target transmission objects actually received at the same time or within a predetermined time 3; a maximum quantity of resource pools for actually receiving target transmission objects at the same time or within a predetermined time 4; a maximum quantity of target transmission objects actually received on X1 carriers or CCs or cells at the same time or within a predetermined time 5; a maximum quantity of target transmission objects actually received on X2 BWPs at the same time or within a predetermined time 6; and a maximum quantity of target transmission objects actually received on X3 resource pools at the same time or within a predetermined time 7.

In a possible example, the actual transmit limit includes at least one of the following:
a quantity M1 of transmit antennas; a quantity M2 of receive antennas; a quantity M3 of transmit antennas and receive antennas; a quantity M4 of transmit chains; a quantity M5 of receive chains; a quantity M6 of transmit chains and receive chains, a maximum quantity of carriers or CCs or cells for actually sending target transmission objects at the same time or within a preset time 8; a maximum quantity of BWPs for actually sending target transmission objects at the same time or within a predetermined time 9; a maximum quantity of target transmission objects actually sent at the same time or within a predetermined time 10; a maximum quantity of resource pools for actually sending target transmission objects at the same time or within a predetermined time 11; a maximum quantity of target transmission objects actually sent on X4 carriers or CCs or cells at the same time or within a predetermined time 12; a maximum quantity of target transmission objects actually sent on X5 BWPs at the same time or within a predetermined time 13; and a maximum quantity of target transmission objects actually sent on X6 resource pools at the same time or within a predetermined time 14.

In a possible example, the actual transmit and receive limit includes at least one of the following:
a quantity M1 of transmit antennas; a quantity M2 of receive antennas; a quantity M3 of transmit antennas and receive antennas; a quantity M4 of transmit chains, a quantity M5 of receive chains; a quantity M6 of transmit chains and receive chains; a maximum quantity of carriers or CCs or cells for actually receiving and sending target transmission objects at the same time or within a preset time 15; a maximum quantity of BWPs for actually receiving and sending target transmission objects at the same time or within a predetermined time 16; a maximum quantity of target transmission objects actually received and sent at the same time or within a predetermined time 17; a maximum quantity of resource pools for actually receiving and sending target transmission objects at the same time or within a predetermined time 18; a maximum quantity of target transmission objects actually received and sent on X7 carriers or CCs or cells at the same time or within a predetermined time 19, a maximum quantity of target transmission objects actually received and sent on X8 BWPs at the same time or within a predetermined time 20; and a maximum quantity of target transmission objects actually received and sent on X9 resource pools at the same time or within a predetermined time 21.

For example, the first limit further includes a first time limit (which may be referred to as Tswitch limit), and the actual limit further includes an actual time limit (which may be referred to as Tswitch limit actual).

In a possible example, the actual time limit includes at least one of the following:
an actual minimum time limit for switching a bearer object;
an actual maximum time limit for switching a bearer object;
an actual minimum time limit for power adjustment;
an actual maximum time limit for power adjustment;
an actual minimum time limit for adjusting a transmission chain;
an actual maximum time limit for adjusting a transmission chain;
an actual time limit for preparing the target transmission object;
an actual time limit for preparing candidate resource reporting; and
an actual time limit required for determining a candidate resource.

In a possible example, TX limit actual≤TX limit.

In a possible example, RX limit actual≤RX limit.

In a possible example, Total limit actual≤Total limit.

In a possible example, Tswitch limit actual≤Tswitch limit.

In addition, the actual limit is determined based on at least one of the following:
a UE capability of the first UE;
a transmission limit configured by the control node;
a transmission limit indicated by another UE;
being preconfigured; and
being predefined in a protocol.

Further, the UE capability includes the target limit.

Further, the UE may report the actual limit to the control node, another UE, or another device.

In an example, the first limit is the actual limit, namely, TX limit actual=TX limit, and/or RX limit actual=RX limit, and/or total limit actual:=total limit.

Further, in this embodiment of this application, there is a first association relationship between the first receive limit and the first transmit limit, and/or
there is a second association relationship between the actual transmit limit and any one of the following:
the actual receive limit;
the first transmit limit and the actual transmit limit;
the first receive limit; and
the first receive limit and the first transmit limit; and/or
there is a third association relationship between the actual receive limit and any one of the following:
the actual transmit limit;
the first receive limit and the actual transmit limit;
the first transmit limit; and
the first receive limit and the first transmit limit, where
the first association relationship is related to at least one of the following preset values:
a first preset value corresponding to the first transmission limit; and
a second preset value corresponding to the first transmission limit;
the second association relationship is related to at least one of the following preset values;
the first preset value corresponding to the first transmission limit; and
a first preset value corresponding to the actual transmission limit; and
the third association relationship is related to at least one of the following preset values;
the second preset value corresponding to the first transmission limit; and
a second preset value corresponding to the actual transmission limit.

For example, the first preset value (for example, Alpha in the following) is less than or equal to a quantity (for example, Alpha0 in the following) of bearer objects that are expected to be received and that are corresponding to at least one time of sending at a moment or within a time range on any bearer object or preset P bearer objects.

For example, the second preset value (for example, beta in the following) is less than or equal to a quantity (for example, beta0 in the following) of bearer objects that are expected to be sent and that are corresponding to at least one time of receiving at a moment or within a time range on any bearer object or preset Q bearer objects.

It should be noted that the first association relationship, the second association relationship, and the third association relationship may also be considered as a predetermined rule. In this case, the first device may infer another limit based on partial known limits and the predetermined rule. For example, the first device may infer the first transmit limit based on the first receive limit and the first association relationship.

For the first transmission limit and the actual transmission limit, the control node, the first device, or another device guarantees at least one of the following:

(1): TX limit=RX limit/alpha, and/or TX limit≥RX limit/alpha0

Alpha (that is, the first preset value corresponding to the first transmission limit)≤Alpha0. Alpha0 is a quantity of bearer objects that are expected to be received and that are corresponding to one or more times of sending (for example, at least one of a carrier, a CC, a cell, a BWP, a resource pool, and a resource) of a specific bearer object. For example, sending of one PSSCH on a specific carrier corresponds to receiving of one or more PSFCHs on one carrier. If alpha0 is interpreted as a quantity of carriers that are expected to be received and that are corresponding to one time of PSSCH sending, alpha0=1. In a possible example, alpha=1.

(2): RX limit=TX limit/beta, and/or RX limit≥TX limit/beta0

Beta (that is, the second preset value corresponding to the first transmission limit) Beta0. Beta0 is a quantity of bearer objects that are expected to be sent and that are corresponding to one or more times of receiving of a specific bearer object. For example, receiving of a plurality of PSFCHs on a specific carrier corresponds to sending of a plurality of PSSCHs on one carrier. If beta0 is interpreted as a quantity of carriers that are expected to be sent and that are corresponding to one time of receiving, beta0=1. For example, receiving of a plurality of PSFCHs on a specific carrier corresponds to sending of PSSCHs on Y carriers. If beta0 is interpreted as a quantity of carriers that are expected to be sent and that are corresponding to one time of receiving, beta0=Y In a possible example, beta=1.

(3): TX limit actual=RX limit actual/alpha actual, and/or
TX limit actual≥RX limit actual/alpha actual0, and/or
TX limit actual=min(TX limit, RX limit actual/alpha actual) or max(TX limit, RX limit actual/alpha actual), and/or
TX limit actual=min(TX limit, RX limit actual/alpha actual0) or max(TX limit, RX limit actual/alpha actual0), and/or
TX limit actual=RX limit/alpha actual, and/or
TX limit actual≥RX limit/alpha actual0, and/or
TX limit actual=min(TX limit, RX limit/alpha actual) or max(TX limit, RX limit/alpha actual), and/or
TX limit actual=min(TX limit, RX limit/alpha actual0) or max(TX limit, RX limit/alpha actual0).
Alpha actual (that is, the first preset value corresponding to the actual transmission limit)≤Alpha actual0.

Alpha actual0 is a quantity of bearer objects that are expected to be received and that are corresponding to one or more times of sending of a specific bearer object. For example, sending of one PSSCH on a specific carrier corresponds to receiving of one or more PSFCHs on one carrier. If alpha actual0 is interpreted as a quantity of carriers that are expected to be received and that are corresponding to one time of sending, alpha actual0=1. In a possible example, alpha actual=1.
(4): RX limit actual=TX limit actual/beta actual, and/or
RX limit actual≥TX limit actual/beta actual0, and/or
RX limit actual=min or max(RX limit, TX limit actual/beta actual), and/or
RX limit actual=min or max(RX limit, TX limit actual/beta actual0), and/or
RX limit actual=TX limit/beta actual, and/or
RX limit actual≥TX limit/beta actual0, and/or
RX limit actual=min or max(RX limit, TX limit/beta actual), and/or
RX limit actual=min or max(RX limit, TX limit/beta actual0).

Beta actual (that is, the second preset value corresponding to the actual transmission limit)≤Beta actual0.

Beta actual0 is a quantity of bearer objects that are expected to be sent and that are corresponding to one or more times of receiving of a specific bearer object. For example, receiving of a plurality of PSFCHs on a specific carrier corresponds to sending of a plurality of PSSCHs on one carrier. If beta actual0 is interpreted as a quantity of carriers that are expected to be sent and that are corresponding to one time of receiving, beta actual0=1. For example, receiving of a plurality of PSFCHs on a specific carrier corresponds to sending of PSSCHs on Y carriers. If beta actual0 is interpreted as a quantity of carriers that are expected to be sent and that are corresponding to one time of receiving, beta actual0=Y In a possible example, beta actual=1.

It should be noted that a result of the foregoing formula needs to be rounded up or down in an indivisible case.

The following describes the target limit in this embodiment of this application by using several examples.

### Example 1—Sending on One Carrier Corresponds to Receiving on One Carrier

For example, it is assumed that the UE can support sending at the same time on three carriers and can support simultaneous receiving on two carriers, that is, TX limit=3 and RX limit=2. In actual transmission, a maximum quantity of carriers for simultaneous sending is =min(2, 3)=2, and a maximum quantity of carriers for simultaneous receiving is =min (2, 3)=2, that is, when the UE performs transmission and/or the control node performs scheduling, it is ensured that a quantity of carriers for simultaneous sending is not greater than 2, and a quantity of carriers for simultaneous receiving is not greater than 2.

### Example 2: Sending on One Carrier Corresponds to Receiving on Alpha0 Carriers

For example, alpha0=2, and sending on a specific carrier corresponds to receiving on two carriers. It is assumed that the UE can support sending at the same time on six carriers, that is, TX limit=6, and RX actual limit or RX limit=6/2=3 When the UE performs transmission and/or the control node performs scheduling, it is ensured that a quantity of carriers for simultaneous receiving is not greater than 3.

### Example 3: Receiving on One Carrier Corresponds to Sending on Beta0 Carriers

For example, beta0=2, and receiving on a specific carrier corresponds to sending on two carriers. It is assumed that the UE can support simultaneous receiving on six carriers, that is, RX limit=6, and TX actual limit or TX limit=6/2=3. When the UE performs transmission and/or the control node performs scheduling, it is ensured that a quantity of carriers for sending at the same time is not greater than 3.

Further, in this embodiment of this application, the actual limit is determined based on the first limit.

Further, in this embodiment of this application, the actual transmission limit is determined based on the first transmission limit and a second predetermined rule, where
the second predetermined rule includes at least one of the following:
at least one of the actual transmission limit is less than or equal to a first value;
at least one of the actual transmission limit is equal to a second value; and
at least one of the actual transmission limit is equal to a third value, where
the first value is a minimum value in the first transmit limit and the first receive limit;
the second value is determined based on the first transmit limit and the first receive limit; and
the third value is determined based on the first transmit and receive limit.

It should be noted that the second predetermined rule may be considered as an association relationship. For example, if at least one of the actual transmission limit is less than or equal to the first value, it may be considered that there is an association relationship between the actual transmission limit and the first transmit limit and the first receive limit, if at least one of the actual transmission limit is equal to the second value, it may be considered that there is an association relationship between the actual transmission limit and the first transmit limit and the first receive limit; and if at least one of the actual transmission limit is equal to the third value, it may be considered that there is an association relationship between the actual transmission limit and the first transmit and receive limit.

For example, the control node, the first UE, or the second UE ensures that at least one of the actual transmission limit is less than or equal to the first value, and the first value:=min(TX limit, RX limit).

For example, the control node, the first UE, or the second UE ensures that at least one of the actual transmission limit (for example, TX limit actual, RX limit actual, or total limit actual) is equal to the second value.

In an example, the second value=min(a×TX limit, b×RX limit), where a and b may be 0, a positive number or a negative number, or a decimal number.

Example 1: TX limit actual=min(TX limit, RX limit).

Example 2: RX limit actual=min(TX limit, RX limit).

In another example, the second value=c×TX limit+d×RX limit, where c and d may be 0, a positive number or a negative number, or a decimal number.

For example, the control node, the first device, or the second UE ensures that at least one of the actual transmission limit is equal to the third value, and the third value=e×total limit, where e may be a positive number, or a decimal number.

In this embodiment of this application, an essence of the transmission method provided in this embodiment of this application is to restrict a relationship between a transmit limit and a receive limit, so that the relationship matches a relationship between sending and receiving. For example, a maximum quantity of carriers for sending is equal to a maximum quantity of carriers for receiving, so that when there is an association between TX and RX, especially when TX on a specific carrier is associated with RX on the carrier or another carrier, a maximum quantity of carriers for actual simultaneous sending is equal to a maximum quantity of carriers for actual simultaneous receiving.

It should be noted that there is a difference between a limit on a quantity of bearer objects and a limit on a quantity of resources. For example, a maximum quantity of bearer objects for simultaneous sending is limited to 2. However, a plurality of PSFCHs may be sent at the same time on each bearer object. Therefore, a maximum quantity of PSFCH resources that are actually sent at the same time may be far greater than 2.

For example, in this embodiment of this application, that transmission of a target transmission object that needs to be performed by the first UE exceeds the target limit includes: the transmission of the target transmission object that is to be transmitted by the first UE exceeds the target limit, or a current capability margin is insufficient.

In a possible example, that transmission of a target transmission object that needs to be performed by the first UE exceeds the target limit includes: second transmission currently performed by the first UE does not exceed the target limit, and third transmission performed by the first UE exceeds the target limit. That is, the current capability margin is insufficient. The second transmission is at least a part of the transmission of a target transmission object, and the third transmission is at least a part of the transmission of the target transmission object.

For example, the third transmission includes any one of the following:
the second transmission and additional transmission based on the second transmission; and
transmission obtained by adjusting the second transmission.

For example, in this embodiment of this application, the dropping, by the first device, first transmission includes:
in a case that a switching condition is met, dropping the first transmission and performing fourth transmission; and
in a case that at least one of the switching condition is not met, dropping the first transmission.

It should be noted that, that the switching condition is not met means, all conditions in the switching condition are not met, or some conditions in the switching condition are not met, or a reverse one of the switching condition is met.

In an example, if the target limit is exceeded when the third transmission is directly performed, other transmission needs to be dropped to perform the third transmission, or the third transmission is dropped.

In an example, the first transmission may be considered as at least a part of the third transmission.

In an example, if the target limit is exceeded when the third transmission is directly performed, performing fourth transmission is switching to a bearer object associated with the fourth transmission for transmission, and/or dropping other transmission. For example, the bearer object associated with the fourth transmission is different from a bearer object associated with the third transmission.

In an example, the switching condition includes at least one of the following:
the target transmission object meets the corresponding target time limit; and
a preset parameter associated with the target transmission object meets a preset condition.

In an example, that the target transmission object meets the corresponding target time limit may be considered as that a transmission moment of the target transmission object meets a time limit in the corresponding target time limit. For example, a time interval between a target resource of the target transmission object and a target resource of another transmission object includes at least a time limit required for processing a PSCCH and/or a PSSCH, and/or a time limit for preparing or processing a PSFCH, and/or a time limit for adjusting an RF chain, and/or a time limit for switching a carrier and/or a CC/BWP/resource pool. For example, the fourth transmission is considered only when time is sufficient to complete the switching.

In an example, that a preset parameter associated with the target transmission object meets a preset condition may include
(1) A preset parameter 1 associated with the target transmission object is equal to or greater than a threshold 1, where the preset parameter 1 may be a priority parameter. For example, transmission is considered only when a priority associated with the target transmission object is greater than the threshold 1.
(2) A preset parameter 2 associated with the another transmission object is equal to or less than a threshold 2, where the preset parameter 2 may be a priority parameter. For example, transmission of the target transmission object is considered only when a priority associated with the another transmission object is less than the threshold 2. In this case, normal transmission of a part of the another transmission object may be affected.
(3) A preset parameter 3 associated with the target transmission object is equal to or less than a threshold 3, where the preset parameter 3 may be a priority value. For example, transmission is considered only when a priority value associated with the target transmission object is less than the threshold 3.
(4) A preset parameter 4 associated with the another transmission object is equal to or less than a threshold 4, where the preset parameter 4 may be a priority value. For example, transmission of the target transmission object is considered only when a priority value associated with the another transmission object is less than the threshold 4. In this case, normal transmission of a part of the another transmission object may be affected.

For example, as shown in FIG. 5, it is assumed that UE TX limit=RX limit=1, and PSSCH resources are separately used for sending in a CC #1 and a CC #2, where a PSSCH sending resource of the CC #1 is associated with PSFCH receiving of the CC #1 There may be.

Example 1: Only when both a time interval between CC #2 PSSCH and CC1 #1 PSSCH and a time interval between CC #2 PSSCH and CC1 #1 PSFCH meet corresponding time limits (for example, a length of the time interval between CCH2 PSSCH and CC1 #1 PSSCH is not less than a time limit for RF adjustment and/or a time limit for switching and/or a length corresponding to a PSCCH/PSSCH preparation time limit, and the time interval between CCH2 PSSCH and CC1 #1 PSFCH is not less than a time limit for RF adjustment and/or a time limit for switching and/or a length corresponding to a PSCCH/PSSCH processing time limit and/or a PSFCH preparation time limit), the UE may transmit CC #2 PSSCH.

Example 2: The foregoing time limit is met, or at least one of the foregoing time limit is not met. Further, if a priority of CC #2 PSSCH is greater than the threshold 1 or a priority value is less than the threshold 3, the UE may transmit CC #2 PSSCH.

Example 3: The foregoing time limit is met, or at least one of the foregoing time limit is not met. Further, if a priority of CC #1 PSSCH is less than the threshold 1 or a priority value is greater than the threshold 4, the UE may transmit CC #2 PSSCH.

Example 4 The UE does not transmit CC #2 PSSCH, but may perform transmission on CC #2 after CC #1 PSFCH.

For example, in this embodiment of this application, the process of dropping first transmission includes: dropping the first transmission according to a first predetermined rule.

In a possible example, the first predetermined rule includes at least one of the following:
according to a priority order of the target transmission object;
according to a priority order of a transmission type of the transmission of the target transmission object;
according to a priority order of the transmission of the target transmission object;
according to information about the target transmission object;
according to a frequency domain location of the transmission of the target transmission object;
according to a time domain location of the transmission of the target transmission object;
according to a time domain location of the transmission of the target transmission object;
according to a Subcarrier Spacing (SCS) of the transmission of the target transmission object; and
according to content or a transmission object type of the transmission of the target transmission object.

For example, if the transmission of the target transmission object that needs to be transmitted by the first UE exceeds the target limit, the first device discards the first transmission until the target limit is not exceeded.

In a possible example, if the first device determines a dropping order based on a plurality of dimensions (for example, one dimension is different rules, and one dimension is different types of bearer objects), the dimensions may be traversed in a traversal order, or traversing may be performed according to a predetermined traversal method.

Taking two dimensions as an example, the traversal method may include:

In an example, for each dimension 1, discarding is performed according to a dimension 2. For example, if the dimension 1 is a carrier or a CC, and the dimension 2 is a priority, a priority of transmission on each carrier or CC is considered, and discarding is performed for each carrier or CC according to a priority order.

In an example, dimensions 2 on all dimensions 1 are sorted and then discarding is performed according to the dimension 2. For example, if the dimension 1 is a carrier or CC, and the dimension 2 is a priority, transmission priorities of all carriers or CCs are considered, and then discarding is performed according to a priority order.

In this embodiment of this application, discarding may be performed according to the information (the information includes at least one of carrier information, CC information, BWP information, resource pool information, a frequency domain location, a time domain location (a start time or an end time), duration, a priority, an SCS, (explicitly or implicitly) carried information or content, and a channel type and/or a signal type) about the associated target transmission object in the foregoing rule.

Further, in this embodiment of this application, the information about the target transmission object includes at least one of the following: coding of the target transmission object, an identifier of the target transmission object, and information about a target object associated with the target transmission object, where the target object includes at least one of the following:
an LCH, an LCG, QOS, a HARQ process, a TB, a data packet, and a PDU.

Further, in this embodiment of this application, the information about the target object associated with the target transmission object includes: a quantity of target objects and/or whether at least a part of same target objects are associated.

Further, in this embodiment of this application, the dropping first transmission according to information about a target object associated with the target transmission object includes: reserving target transmission objects on bearer objects associated with a same target object, and/or discarding target transmission objects on bearer objects associated with different target objects.

In a possible example, if transmission on a target bearer object exceeds the target transmission limit, the first device may multiplex transmission on at least a part of bearer objects in the target bearer object to another bearer object in the target bearer object, where the at least a part of bearer objects in the target bearer object and the another bearer object are associated with a same target object.

Further, the multiplexing transmission on at least a part of bearer objects in the target bearer object to another bearer object in the target bearer object includes: multiplexing transmission on the at least a part of bearer objects in the target bearer object to the another bearer object in the target bearer object by using an LCP of MAC.

The process of discarding the first transmission is described below by using examples.

(A) The foregoing discard process is performed according to information about a bearer object of the target transmission object (for example, an index or an II) of a carrier and/or a CC/BWP/resource pool):

Example 1a: Discarding may be performed in descending order or ascending order of numbers (for example, indexes or IDs) of bearer objects.

Example 2a: Discard a target transmission object on a bearer object whose index or ID is not greater than a preset index or ID, or discard a target transmission object on a bearer object whose index or ID is not less than a preset index or ID.

(B) The foregoing discard process is performed according to a target object associated with (for example, carried in) a bearer object of the target transmission object (for example, at least one of data, an LCH, an LCG, QOS, a HARQ process, a TB, a packet, and a PDU).

Example 1b: Discarding may be performed according to a quantity of target objects associated with bearer objects of the target transmission object.

For example, discarding is performed in ascending order or descending order of quantities of associated target objects; or discard target transmission objects on bearer objects (for example, a carrier or a CC or a cell or a BWP or a resource pool) associated with target objects whose quantity is not greater than a preset quantity; or discard target transmission objects on bearer objects associated with target objects whose quantity is not less than a preset quantity.

Example 2b: Perform discarding according to whether a same target object is associated (or carried).

For example, if there are target transmission objects on bearer objects associated with a same target object this type of bearer object is reserved, and target transmission objects on bearer objects associated with different target objects are discarded. For example, different QoS or LCH channels are associated with different CCs. It is determined, according to a multiplexed LCH in a TB, which CCs are reserved or which CCs are discarded. For example, if an LCH 1 is multiplexed and the LCH 1 is associated with a CC 1 and a CC 2, the CC 1 and the CC 2 are reserved, and other (CCs are discarded.

For example, if there are target transmission objects on bearer objects associated with a same target object, and normal transmission on these bearer objects exceeds the target limit, transmission on at least a part of bearer objects in these bearer objects is multiplexed to at least a part of remaining bearer objects, so that transmission on these bearer objects does not exceed the target limit. For example, if a TX limit or capability is exceeded, transmission that is supposed to be performed on N CCs may be multiplexed to M (where M is less than N) of the N CCs for sending by means of LCP multiplexing of MAC.

(C) The foregoing discard process is performed according to a frequency domain location (the frequency domain location may be a frequency domain location of a target resource of the target transmission object, or may be a frequency domain location of a bearer object associated with a target resource of the target transmission object).

Example 1c: Perform discarding in descending order or ascending order of frequency domain locations.

Example 2c: Discard a target transmission object on a bearer object whose frequency domain location is not higher than a first preset location.

Example 3c: Discard a target transmission object on a bearer object whose frequency domain location is not lower than a first preset location.

(D) The foregoing discard process is performed according to a time domain location (the time domain location may be a start time of a target resource of the target transmission object or may be an end time of a target resource of the target transmission object).

Example 1d: Perform discarding according to a start time of a time domain location or perform discarding according to an end time of the time domain location.

Example 2d: Discard a target transmission object on a bearer object whose start time or end time is not earlier than a second preset location.

Example 3d: Discard a target transmission object on a bearer object whose start time or end time is not later than a second preset location.

(E) The foregoing discard process is performed according to duration (the duration may be duration of a target resource of the target transmission object).

Example 1e: Discarding may be performed in ascending order or descending order of duration.

Example 2e: First discard a target transmission object on a bearer object whose duration is not greater than preset duration.

Example 3e: First discard a target transmission object on a bearer object whose duration is not less than preset duration.

(F) The foregoing discard process is performed according to a priority.

For example, the priority may be a priority of a bearer object of the target transmission object (for example, the priority of the bearer object may be a priority of a target object associated with the bearer object). For example, if there are a plurality of priorities, the priority may be a highest or lowest priority.

For example, the priority may be a priority of information or content carried in the target transmission object, and the priority of the carried information or content may be a priority of a carried TB or an associated HARQ process or LCH or LCG. For example, if there are a plurality of priorities, the priority may be a highest or lowest priority. For example, if the target transmission object is PSFCH receiving, the priority may be a priority of a corresponding PSCCH and/or PSSCH. For example, if the first transmission object reserves subsequent sending (that is, expected sending associated with the first transmission object), a priority of the reserved resource may be a priority of the first transmission object.

For example, the performing dropping according to a priority includes any one of the following:
(1) Start discarding in ascending order or descending order of priorities.
(2) Discard a target transmission object on a bearer object whose priority is equal to or less than a preset priority.
(3) Do not discard or reserve transmission on at least one bearer object whose priority is equal to or greater than a preset priority.
(4) Discard a target transmission object on a bearer object whose priority value is equal to or greater than a preset priority value.
(5) Do not discard or reserve a target transmission object on a bearer object whose priority value is equal to or less than a preset priority value.

(G) Perform discarding according to an SCS

For example, the SC'S may be an SC'S of the target transmission object, or may be an SCS of a bearer object associated with a target resource of the target transmission object.

For example, discarding is performed in ascending order or descending order of SCSs, or a target transmission object on a bearer object whose SCS is greater than a preset value is discarded; or a target transmission object on a bearer object whose SCS is less than a preset value is discarded or modified.

(H) Perform discarding according to information or content (explicitly or implicitly) carried on a bearer object.

For example, discarding is performed when the (explicitly or implicitly) carried information or content is a NACK or the (explicitly or implicitly) carried information or content includes more than a preset quantity of NACKs;
discarding is performed when the (explicitly or implicitly) carried information or content includes less than a preset quantity of ACKs;
discarding is performed when the (explicitly or implicitly) carried information or content is an ACK or the (explicitly or implicitly) carried information or content includes more than a preset quantity of ACKs; or
discarding is performed when the (explicitly or implicitly) carried information or content includes less than a preset quantity of NACKs.

(I) Perform discarding according to a channel type or a signal type of the target transmission object.

For example, a processing object type is a channel type. Discarding may be performed according to a channel/signal type of the target transmission object. For example, when both a PSFCH and a PSSCH exist and a corresponding limit is not met, the PSSCH is discarded, and it is considered whether to drop the PSFCH.

For example, in this embodiment of this application, the target transmission object includes a first transmission object and/or a second transmission object, where a transmission manner corresponding to the first transmission object is sending, and a transmission manner corresponding to the second transmission object is receiving.

It should be noted that, the transmission corresponding to the first transmission object and expected transmission corresponding to the first transmission object exceed the corresponding target limit, which means that total transmission of the transmission corresponding to the first transmission object and the expected transmission corresponding to the first transmission object exceeds the corresponding target limit. For example, a total of the transmission corresponding to the first transmission object and the expected transmission corresponding to the first transmission object exceeds a corresponding maximum quantity limit.

It should be noted that the expected transmission associated with the sending may be corresponding expected receiving, or may be associated and/or triggered subsequent sending (for example, sending 1 reserves future resources for subsequent sending). The expected transmission associated with the receiving may be corresponding expected sending, or may be associated and/or triggered subsequent receiving (for example, receiving 1 reserves future resources for subsequent receiving).

It should be noted that the expected transmission in this specification may also be understood as candidate transmission.

Further, in this embodiment of this application, if the target transmission object includes at least the first transmission object, the exceeding the target limit includes any one of the following:
the transmission corresponding to the first transmission object exceeds the corresponding target limit;
expected transmission associated with the first transmission object exceeds the corresponding target limit; and
the transmission corresponding to the first transmission object does not exceed the corresponding target limit, and the expected transmission associated with the first transmission object exceeds the corresponding target limit, where
the first transmission includes first sending and/or first expected transmission;
the first sending is a transmission corresponding to at least a part of the first transmission object; and
the first expected transmission is expected transmission associated with the transmission corresponding to at least a part of the first transmission object.

On this basis, further, in this embodiment of this application, the dropping first transmission includes at least one of the following
performing dropping until the number of remaining first sending is not greater than a first predetermined quantity; and
performing dropping until the number of remaining first expected transmission is not greater than a second predetermined quantity.

For example, in a case that the target resource of the first transmission object is used for sending, if the target limit is exceeded, for example, TX limit and/or TX limit actual and/or RX limit and/or RX limit actual are/is exceeded, at least one of the following cannot be ensured:
(a-i) A target resource or sending of a first transmission object (at the same time or within a preset time range) does not exceed the target limit (for example, does not exceed TX limit and/or TX limit actual, and/or does not exceed RX limit and/or RX limit actual).
(a-ii) Expected receiving of a fifth transmission object corresponding to a target resource or sending of a first transmission object (at the same time or within a preset time range) does not exceed the target limit (for example, expected receiving corresponding to first transmission does not exceed RX limit and/or RX limit actual).

In a possible example, if (a-i) cannot be ensured, the first device discards at least a part of the target resource or sending of the first transmission object on the at least a part of the bearing object, and/or at least a part of the corresponding expected transmission (for example, the expected receiving) of the fifth transmission object.

In an example, the first transmission object and/or the fifth transmission object associated with the first transmission object may be discarded according to information (the information includes at least one of carrier information, CC information, BWP information, resource pool information, a frequency domain location, a time domain location sequence (a start time and an end time), duration, a priority, an SCS, (explicitly or implicitly) carried information or conent, and a channel type and/or a signal type) about a target transmission object associated with the target resource or sending of the first transmission object.

In another example, the fifth transmission object and/or the first transmission object corresponding to the fifth transmission object are/is discarded according to information (the information includes at least one of carrier information, CC information, BWP information, resource pool information, a frequency domain location, a time domain location (a start time and an end time), duration, a priority, an SCS, (explicitly or implicitly) carried information or content, and a channel type and/or a signal type) about a target transmission object associated with the expected receiving of the fifth transmission object associated with the first transmission object. For example, some carriers and/or CCs are first discarded according to carrier numbers and/or CC numbers, and then sending corresponding to receiving of a carrier and/or CC with a lower priority is discarded according to a priority of a remaining carrier and/or CC.

In another example, a first transmission object corresponding to a preset parameter 1 and/or a fifth transmission object associated with the first transmission object are/is discarded, and/or a fifth transmission object corresponding to a preset parameter 2 and/or a first transmission object associated with the fifth transmission object are/is discarded. For example, the preset parameter includes information (the information includes at least one of carrier information, CC information, BWP information, resource pool information, a frequency domain location, a priority, an SCS, (explicitly or implicitly) carried information or content, and a channel type/signal type) about a transmission object.

In an example, the discarding includes at least one of the following:
performing dropping until only the number of remaining target resources or sending of a first transmission object is not greater than a predetermined quantity 1 (for example, performing discarding until the number of remaining target resources or sending of the first transmission object does not exceed TX limit and/or TX limit actual); and
performing dropping until only the number of remaining first expected transmission of a fifth transmission object associated with a first transmission object is not greater than a predetermined quantity 2 (for example, performing discarding until the number of remaining expected receiving of the fifth transmission object does not exceed RX limit and/or RX limit actual).

In another possible example, (a-i) can be ensured but (a-ii) cannot be ensured, that is, the target resource or sending of the first transmission object does not exceed the target limit, but the expected transmission of the fifth transmission object associated with the first transmission object exceeds the target limit. For example, if the sending does not exceed TX limit and/or TX limit actual but the expected receiving of the fifth transmission object corresponding to the sending exceeds RX limit and/or RX limit actual, the first device discards at least a part of the target resource or sending of the first transmission object on the at least a part of the bearing object, and/or at least a part of the corresponding expected transmission (for example, the expected receiving) of the fifth transmission object.

In an example, the first transmission object and/or the fifth transmission object associated with the first transmission object may be discarded according to information (including at least one of carrier information, CC information, BWP information, resource pool information, a frequency domain location, a priority, an SCS, (explicitly or implicitly) carried information or content, and a channel type/signal type) about a target transmission object associated with the target resource or sending of the first transmission object.

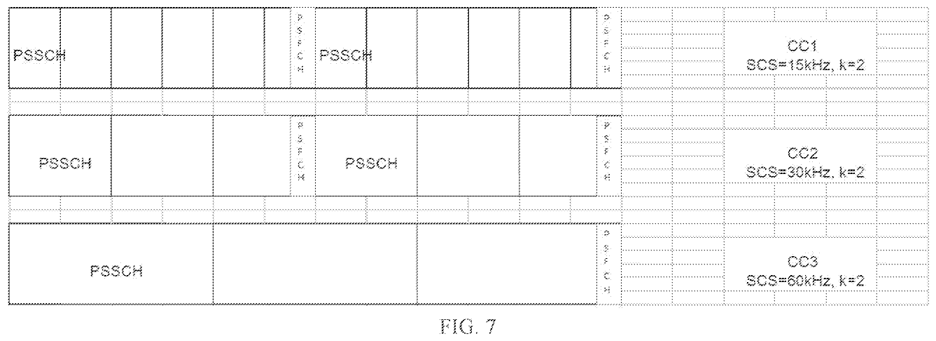

In another example, the fifth transmission object and/or the first transmission object corresponding to the fifth transmission object are/is discarded according to information (including at least one of carrier information, CC information, BWP information, resource pool information, a frequency domain location, a priority, an SCS, (explicitly or implicitly) carried information or content, and a channel type/signal type) about a target transmission object associated with the expected receiving of the fifth transmission object associated with the first transmission object. For example, the first transmission object is a PSCCH and/or a PSSCH, and the fifth transmission object is a PSFCH. Referring to FIG. 7, a PSSCH corresponding to a PSFCH with a highest CC ID is discarded, that is, PSSCH sending on a carrier and/or CC 3.

In another example, a first transmission object corresponding to a preset parameter 3 and/or a fifth transmission object associated with the first transmission object are/is discarded, and/or a fifth transmission object corresponding to a preset parameter 4 and/or a first transmission object associated with the fifth transmission object are/is discarded. For example, the preset parameter is information (the information includes at least one of carrier information, CC information, BWP information, resource pool information, a frequency domain location, a priority, an SCS, (explicitly or implicitly) carried information or content, and a channel type/signal type) about a transmission object.

In an example, the discarding includes at least one of the following:
performing discarding until only a target resource or sending of a first transmission object not greater than a predetermined quantity 1′ remains; and
performing discarding until only expected transmission of a fifth transmission object not greater than a predetermined quantity 2′ is remains (for example, performing discarding until remaining expected receiving of the fifth transmission object does not exceed RX limit and/or RX limit actual).

Further, in this embodiment of this application, if the target transmission object includes at least the second transmission object, the exceeding the target limit includes any one of the following:
the receiving corresponding to the second transmission object exceeds the corresponding target limit;
expected transmission associated with the second transmission object exceeds the corresponding target limit; and
the receiving corresponding to the second transmission object does not exceed the corresponding target limit, and the expected transmission associated with the second transmission object exceeds the corresponding target limit, where
the first transmission includes first receiving and/or second expected transmission;
the first receiving is receiving corresponding to at least a part of the second transmission object; and
the second expected transmission is expected transmission associated with receiving corresponding to at least a part of the second transmission object.

On this basis, further, in this embodiment of this application, the dropping first transmission includes at least one of the following:
performing dropping until the number of remaining first receiving is not greater than a third predetermined quantity; and
performing dropping until the number of remaining second expected transmission is not greater than a fourth predetermined quantity.

For example, in a case that the target resource of the first transmission object is used for sending, if the target limit is exceeded, for example, TX limit and/or TX limit actual and/or RX limit and/or RX limit actual are/is exceeded, at least one of the following cannot be ensured:
(b-i) A target resource or receiving of a second transmission object (at the same time or within a preset time range) does not exceed the target limit (for example, does not exceed TX limit and/or TX limit actual, and/or does not exceed RX limit and/or RX limit actual).
(b-ii) Expected sending of a sixth transmission object corresponding to a target resource or receiving of a second transmission object (at the same time or within a preset time range) does not exceed the target limit (for example, expected receiving corresponding to a first transmission object does not exceed TX limit and/or TX limit actual).

In a possible example, if (b-i) cannot be ensured, the first device discards at least a part of the target resource or receiving of the second transmission object on the at least a part of the bearing object, and/or at least a part of the corresponding expected transmission (for example, the expected sending) of the sixth transmission object.

In an example, the second transmission object and/or the sixth transmission object associated with the second transmission object may be discarded according to information (the information includes at least one of carrier information, CC information, BWP information, resource pool information, a frequency domain location, a priority, an SCS, (explicitly or implicitly) carried information or content, and a channel type/signal type) about a target transmission object associated with the target resource or receiving of the second transmission object. For example, some carriers and/or CCs are first discarded according to carrier numbers and/or CC numbers, and then receiving with a lower priority is discarded according to a priority of a remaining carrier and/or CC.

In another example, the sixth transmission object and/or the second transmission object corresponding to the sixth transmission object are/is discarded according to information (the information includes at least one of carrier information, CC information, BWP information, resource pool information, a frequency domain location, a priority, an SCS, (explicitly or implicitly) carried information or content, and a channel type/signal type) about a target transmission object associated with the expected sending of the sixth transmission object associated with the second transmission object.

In another example, a second transmission object corresponding to a preset parameter 5 and/or a sixth transmission object associated with the second transmission object are/is discarded, and/or a sixth transmission object corresponding to a preset parameter 6 and/or a second transmission object associated with the sixth transmission object are/is discarded. For example, the preset parameter is information (the information includes at least one of carrier information, CC information, BWP information, resource pool information, a frequency domain location, a priority, an SCS, (explicitly or implicitly) carried information or content, and a channel type/signal type) about a transmission object.

In an example, the discarding includes at least one of the following:
performing dropping until only the number of remaining target resources or receiving of a second transmission object is not greater than a predetermined quantity 3 (for example, performing discarding until the number of remaining target resources or receiving of the second transmission object does not exceed RX limit and/or RX limit actual); and
performing dropping until only the number of remaining first expected transmission of a sixth transmission object associated with a second transmission object is not greater than a predetermined quantity 4 (for example, performing discarding until the number of remaining expected sending of the sixth transmission object does not exceed TX limit and/or TX limit actual).

In another possible example, (b-i) can be ensured but (b-ii) cannot be ensured, that is, the target resource or receiving of the second transmission object does not exceed the target limit, but the expected transmission of the sixth transmission object associated with the second transmission object exceeds the target limit. For example, if the sending does not exceed TX limit and/or TX limit actual but the expected sending of the sixth transmission object corresponding to the sending exceeds RX limit and/or RX limit actual, the first device discards at least a part of the target resource or receiving of the second transmission object on the at least a part of the bearing object, and/or the at least a part of the expected transmission (for example, the expected sending) of the sixth transmission object associated with the transmission corresponding to the second transmission object.

In an example, the second transmission object and/or the sixth transmission object associated with the second transmission object may be discarded according to information (the information includes at least one of carrier information, CC information, BWP information, resource location information, a frequency domain location, a priority, an SCS, (explicitly or implicitly) carried information or content, and a channel type/signal type) about a target transmission object associated with the target resource or receiving of the second transmission object.

In another example, the sixth transmission object and/or the second transmission object corresponding to the sixth transmission object are/is discarded according to information (the information includes at least one of carrier information, CC information, BWP information, resource pool information, a frequency domain location, a priority, an SCS, (explicitly or implicitly) carried information or content, and a channel type/signal type) about a target transmission object associated with the expected receiving of the sixth transmission object associated with the second transmission object. For example, the second transmission object is a PSCCH and/or a PSSCH, and the sixth transmission object is a PSFCH. Referring to FIG. 7, a PSSCH corresponding to a PSFCH with a highest CC ID is discarded, that is, PSSCH sending on a carrier and/or CC 3.

In another example, a second transmission object corresponding to a preset parameter 7 and/or a sixth transmission object associated with the second transmission object are/is discarded, and/or a sixth transmission object corresponding to a preset parameter 8 and/or a second transmission object associated with the sixth transmission object are/is discarded. For example, the preset parameter is information (the information includes at least one of carrier information, CC information, BWP information, resource pool information, a frequency domain location, a priority, an SC'S, (explicitly or implicitly) carried information or content, and a channel type/signal type) about a transmission object.

In an example, the discarding includes at least one of the following:
performing discarding until only a target resource or receiving of a second transmission object not greater than a predetermined quantity 3′ remains; and
performing discarding until only expected transmission of a sixth transmission object not greater than a predetermined quantity 4′ remains (for example, performing discarding until remaining expected sending of the sixth transmission object does not exceed TX limit and/or TX limit actual).

For example, in this embodiment of this application, if the target transmission object includes the first transmission object and the second transmission object, the exceeding the target limit includes at least one of the following:
the transmission corresponding to the first transmission object and the receiving corresponding to the second transmission object exceed the corresponding target limit;
the transmission corresponding to the first transmission object and expected transmission associated with the second transmission object exceed the corresponding target limit;
expected transmission associated with the first transmission object and the expected transmission associated with the second transmission object exceed the corresponding target limit; and
the receiving corresponding to the second transmission object and the expected transmission associated with the first transmission object exceed the corresponding target limit, where
the first transmission includes at least one of the following:
second sending, third expected transmission, second receiving, and fourth expected transmission;
the second sending is a transmission corresponding to at least a part of the first transmission object;
the third expected transmission is expected transmission associated with the transmission corresponding to at least a part of the first transmission object;
the second receiving is receiving corresponding to at least a part of the second transmission object; and
the fourth expected transmission is expected transmission associated with receiving corresponding to at least a part of the second transmission object.

On the foregoing basis, further, in this embodiment of this application, the dropping first transmission includes at least one of the following:
performing dropping until the number of remaining fifth transmission is not greater than a fifth predetermined quantity;
performing dropping until the number of remaining sixth transmission is not greater than a sixth predetermined quantity; and
performing dropping until the number of remaining seventh transmission is not greater than a seventh predetermined quantity, where
the fifth transmission includes at least one of the following: first target transmission (Y1), second target transmission (X2), and first target transmission (Y1) and second target transmission (X2);
the sixth transmission includes at least one of the following: third target transmission (X1), fourth target transmission (Y2), and third target transmission (X1) and fourth target transmission (Y2);
the seventh transmission includes at least one of the following: third target transmission (X1), first target transmission (Y1), and third target transmission (X1) and first target transmission (Y1);
the first target transmission is the fourth expected transmission, the second target transmission is the third expected transmission, the third target transmission is the second sending, and the fourth target transmission is the second receiving; or
the first target transmission is the third expected transmission, the second target transmission is the fourth expected transmission, the third target transmission is the second receiving, and the fourth target transmission is the second sending; or
the first target transmission is the second receiving, the second target transmission is the third expected transmission, the third target transmission is the second sending, and the fourth target transmission is the fourth expected transmission; or
the first target transmission is the fourth expected transmission, the second target transmission is the second sending, the third target transmission is the third expected transmission, and the fourth target transmission is the second receiving.

For example, in a case that the target resource of the first transmission object is used for sending and the target resource of the second transmission object is used for receiving, if the first transmission object and the second transmission object exceed the target limit, for example, exceed TX limit and/or X limit actual and/or RX limit and/or RX limit actual, at least one of the following cannot be ensured:
(c-1): A target resource or sending of a first transmission object (at the same time or within a preset time range) does not exceed the target limit.
(c-2) Expected receiving of a fifth transmission object corresponding to a target resource or sending of a first transmission object (at the same time or within a preset time range) does not exceed the target limit.
(c-3) A target resource or receiving of a second transmission object (at the same time or within a preset time range) does not exceed the target limit.
(c-4) Expected sending of a sixth transmission object corresponding to a target resource or receiving of a second transmission object (at the same time or within a preset time range) does not exceed the target limit.
(c-5) At least two of a target resource or sending of a first transmission object, a target resource or receiving of a second transmission object, expected receiving of a fifth transmission object corresponding to the target resource or sending of the first transmission object, and expected sending of a sixth transmission object corresponding to the target resource or receiving of the second transmission object do not exceed the corresponding target limit (for example, do not exceed TX limit and/or TX limit actual, do not exceed RX limit and/or RX limit actual, or do not exceed total limit and/or total limit actual).

In an example, the not exceeding the corresponding target limit includes:

For example, a target resource or sending of a first transmission object and expected sending of a sixth transmission object corresponding to a target resource or receiving of a second transmission object (at the same time or within a preset time range) do not exceed TX limit and/or TX limit actual.

For example, a target resource or receiving of a second transmission object and expected receiving of a fifth transmission object corresponding to a target resource or sending of a first transmission object (at the same time or within a preset time range) do not exceed RX limit and/or RX limit actual.

For example, a target resource or sending of a first transmission object and a target resource or receiving of a second transmission object (at the same time or within a preset time range) do not exceed total limit and/or total limit actual.

For example, expected receiving of a fifth transmission object corresponding to a target resource or sending of a first transmission object and expected receiving of a sixth transmission object corresponding to a target resource or sending of a second transmission object (at the same time or within a preset time range) do not exceed total limit and/or total limit actual.

In an example, for the foregoing scenarios, the UE may drop at least a part of X1 on at least a part of the bearer object, and/or X2 corresponding to X1 on at least a part of the bearer object, and/or at least a part of Y1 on at least a part of the bearer object, and/or Y2 corresponding to Y1 on at least a part of the bearer object.

In an example, that the first device may perform discarding according to the preset rule includes at least one of the following:

Example 1: Discard X1 and/or corresponding X2 according to information associated with X1 (including at least one of carrier information, CC information, BWP information, resource pool information, a frequency domain location, a priority, an SCS, (explicitly or implicitly) carried information or content, and a channel type/signal type).

Example 2: Discard X2 and corresponding X1 according to information associated with X2 (including at least one of carrier information, CC information, BW P information, resource pool information, a frequency domain location, a priority, an SCS, (explicitly or implicitly) carried information or content, and a channel type/signal type).

Example 3: Discard Y1 and corresponding Y2 according to information associated with Y1 (including at least one of carrier information, CC information, BW P information, resource pool information, a frequency domain location, a priority, an SCS, (explicitly or implicitly) carried information or content, and a channel type/signal type).

Example 4: Discard Y2 and corresponding Y1 according to information associated with Y2 (including at least one of carrier information, CC information, BW P information, resource pool information, a frequency domain location, a priority, an SCS, (explicitly or implicitly) carried information or content, and a channel type/signal type).

Example 5: Discard X1 corresponding to a preset parameter 9, and/or Y1 corresponding to a preset parameter 10, and/or X2 corresponding to a preset parameter 11, and/or Y2 corresponding to a preset parameter 12.

In an example, the discarding includes at least one of the following:
(1) Perform discarding/dropping until Y1 and/or X2 are/is not greater than a ninth predetermined quantity (for example, perform discarding/dropping until at least one of the remaining Y1 and X2 does not exceed RX limit and/or RX limit actual).
(2) Perform discarding/dropping until X1 and/or Y2 are/is not greater than a tenth predetermined quantity (for example, perform discarding/dropping until at least one of the remaining X1 and/or Y2 does not exceed TX limit and/or TX limit actual).
(3) Perform discarding/dropping until X1 and Y1 are not greater than an eleventh predetermined quantity (for example, perform discarding/dropping until at least one of the remaining X1 and/or Y1 does not exceed total limit and/or total limit actual).

For example, in this embodiment of this application, the target transmission object includes a third transmission object. Before the dropping first transmission, the technical solution provided in this embodiment of this application further includes:

Step 301: Determine, in a first time, whether transmission of the third transmission object within a second time exceeds the target transmission limit; and/or determine, in a third time, whether to drop the first transmission.

Further, in this embodiment of this application, the first time and/or the third time are before the second time; and/or duration of a time interval between the second time and the first time includes at least (that is, is not less than) duration corresponding to at least one time limit in the target time limit; and/or duration of a time interval between the second time and the third time includes at least duration corresponding to at least one time limit in the target time limit.

Further, in this embodiment of this application, a moment of judging and/or determining whether the target limit is exceeded, a moment of judging and/or determining whether a part of sending or receiving needs to be discarded, and a moment of switching a bearer object may be defined.

For example, before the dropping first transmission, the technical solution provided in this embodiment of this application further includes:

Step 301: Determine, in a fourth time, whether transmission of a fourth transmission object associated with the third transmission object exceeds the target transmission limit, where the transmission of the fourth transmission object is within a fifth time.

Further, in this embodiment of this application, there is a correspondence between a bearer object associated with the third transmission object and a bearer object associated with the fourth transmission object; and/or the bearer object associated with the third transmission object is at least partially the same as the bearer object associated with the fourth transmission object.

Further, in this embodiment of this application,
the first time and/or the third time are/is before the second time; and/or
duration of a time interval between the second time and the first time includes at least duration corresponding to at least one time limit in the target time limit; and/or
duration of a time interval between the second time and the third time includes at least duration corresponding to at least one time limit in the target time limit; and/or
the fourth time and/or the third time are/is before the fifth time; and/or
duration of a time interval between the fifth time and the fourth time includes at least duration corresponding to at least one time limit in the target time limit; and/or
duration of a time interval between the fifth time and the third time includes at least duration corresponding to at least one time limit in the target time limit.

Further, in this embodiment of this application, the determining, in a third time, whether to drop the first transmission includes at least one of the following:
in a case that a first predetermined condition is met, determining, in the third time, whether to drop at least a part of transmission of the third transmission object; and
in a case that a second predetermined condition is met, determining, in the third time, whether to drop at least a part of transmission of the fourth transmission object.
In a possible example, the first predetermined condition includes at least one of the following:
the first time and/or the third time are/is before the second time,
duration of a time interval between the second time and the first time includes at least duration corresponding to at least one time limit in the target time limit; and
duration of a time interval between the second time and the third time includes at least duration corresponding to at least one time limit in the target time limit.

In a possible example, the second predetermined condition includes at least one of the following:
the fourth time and/or the third time are/is before the fifth time;
duration of a time interval between the fifth time and the fourth time includes at least duration corresponding to at least one time limit in the target time limit; and
duration of a time interval between the fifth time and the third time includes at least duration corresponding to at least one time limit in the target time limit.

The following exemplarily describes the foregoing solution by using an example in which the third transmission object is A and the fourth transmission object associated with the third transmission object is B. For example, assuming that A is the first transmission object above, B is the fifth transmission object associated with A. and assuming that A is the second transmission object above, B is the sixth transmission object associated with A.

(1) For example, for A and B, at least one of the following features exists;

(a) There is a correspondence between at least a part of bearer objects associated with A and B, or at least a part of the bearer objects is the same.

(b) If there is another target resource C for sending or receiving that is not associated with A or B, and transmission of C is performed, the limit may be exceeded.

In an example, transmission may include the foregoing target resource C. That is, the fourth transmission performed above includes the target resource C.

In an example, C is not located between a time domain of A and a time domain of B. In some alternative embodiments, it can be explained that C that is not located between the time domain of A and the time domain of B may be normally transmitted.

Example 1: If B is not earlier than A, C must be located behind B or oC is located before A.

Example 2: A is sending of a PSSCH on a slot n on a CC #1, and B is receiving of a PSFCH on a slot n+k associated with the PSSCH on the CC #1. Therefore, it needs to be ensured that a PSSCH on a CC #2 is before the slot n or after the slot n+k, or only a PSSCH before the slot n or after the slot n+k on the CC #2 can be normally transmitted.

In an example, C that is not located between the time domain of A and the time domain of B may be discarded.

(2) Judge/Determine, at a moment 2 (that is, the foregoing first time), whether A at a moment 1 or within a preset time range 1 (that is, the foregoing second time) exceeds the target limit, and/or judge/determine, at a moment 3 (that is, the foregoing third time), whether at least a part of A needs to be discarded and/or whether switching and/or transmission of C need/needs to be performed.

(a) In some embodiments, the moment 2 and/or the moment 3 are/is before the moment 1 or the preset time range 1, or it is ensured that the moment 1 or the preset time range 1 is after the moment 2 and/or the moment 3.

For example, a start point of the moment 1 or a start point of the preset time range 1 is after the moment 2 and/or the moment 3.

(b) In some embodiments, it is ensured that duration of an interval between the moment 1 or the preset time range 1 and the moment 2 includes at least duration corresponding to at least one time limit in the foregoing switching time limit.

For example, the at least one time limit includes a time limit required for determining a candidate resource, or a time limit required for reporting a candidate resource.

For example, the at least one time limit includes a time limit required for processing a PSCCH and/or a PSSCH.

(c) In some embodiments, it is ensured that duration of an interval between the moment 1 or the preset time range 1 and the moment 3 includes at least duration corresponding to at least one time limit in the foregoing switching time limit.

For example, the at least one time limit includes a time limit required for determining a candidate resource, or a time limit required for reporting a candidate resource.

For example, the at least one time limit includes a time limit required for processing a PSCCH and/or a PSSCH.

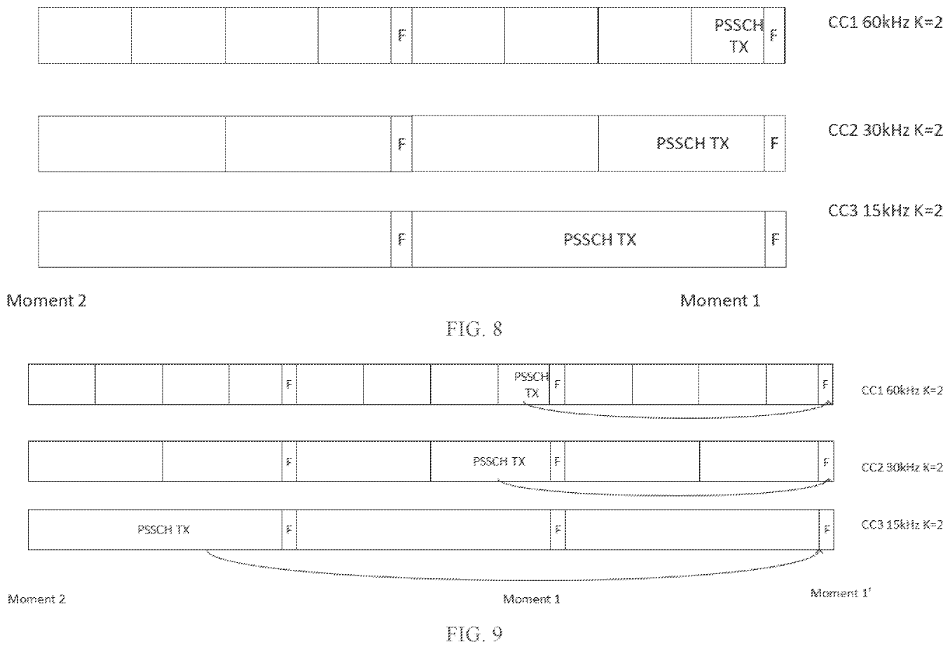

For example, it is assumed that in a case that A is sending, it is determined whether A exceeds the target limit. Referring to FIG. 8, candidate resources for sending a PSSCH exist on three carriers at a moment 1, and the UE determines, at a moment 2, whether the corresponding target limit (for example, TX limit=2) is exceeded. In this case, it is determined that the target limit is exceeded. Further, candidate resources for sending the PSSCH on at least a part of the carriers are discarded at a moment 3.

(3) Judge/Determine, at a moment T (that is, the foregoing fourth time), whether B that is associated with A at a moment 1 or within a preset time range 1 and that is at a moment 1′ or within a preset time range 1′ (that is, the foregoing fifth time) exceeds the transmission limit/the actual transmission limit, and/or judge/determine, at a moment 3, whether at least a part of B and/or A need/needs to be discarded and/or whether switching and/or transmission of C need/needs to be performed.

(a) In some embodiments, the moment 2 and/or the moment 3 are/is before the moment 1 or the preset time range 1, or the moment 1 or the preset time range 1 is after the moment 2 and/or the moment 3. In other words, a start point of the moment 1 or a start point of the preset time range 1 is after the moment 2 and the moment 3.

In an example, this rule applies when it is determined whether to discard at least A.

(b) In some embodiments, duration of an interval between the moment 1 or the preset time range 1 and the moment 2 includes at least duration corresponding to at least one time limit in the foregoing switching time limit.

In an example, this rule applies when it is determined whether to discard at least A.

(c) In some embodiments, duration of an interval between the moment 1 or the preset time range 1 and the moment 3 includes at least duration corresponding to at least one type pf time limit in the foregoing switching time limit.

In an example, this rule applies when it is determined whether to discard at least A.

(d) In some embodiments, a moment 2′ and/or the moment 3 are before the moment 1′ or the preset time range 1′, or the moment P′ or the preset time range 1′ is after the moment 2 and/or the moment 3. In other words, a start point of the moment 1′ or a start point of the preset time range 1′ is after the moment 2′ and/or the moment 3.

In an example, this rule applies when it is determined whether to discard at least B.

(e) In some embodiments, duration of an interval between the moment 1′ or the preset time range 1′ and the moment 2′ includes at least duration corresponding to at least one time limit in the foregoing switching time limit.

In an example, this rule applies when it is determined whether to discard at least B.

In an example, the at least one time limit includes a time limit required for processing a PSCCH and/or a PSSCH, and/or a time limit for preparing or processing a PSFCH, and/or a time limit for adjusting an RF chain, and/or a time limit for switching a carrier and/or a CC/BWP/resource pool.

(f) In some embodiments, duration of an interval between the moment 1′ or the preset time range 1′ and the moment 3 includes at least duration corresponding to at least one time limit in the foregoing switching time limit.

In an example, this rule applies when it is determined whether to discard at least B.

In an example, the at least one time limit includes a time limit required for processing a PSCCH and/or a PSSCH, and/or a time limit for preparing or processing a PSFCH, and/or a time limit for adjusting an RF chain, and/or a time limit for switching a carrier and/or a CC/BWP/resource pool.

For example, if A is sending and B is receiving, it is determined whether 13 exceeds the limit.

Scenario 1: As shown in FIG. 9, at a moment 1, expected receiving of a PSFCH exists on three carriers, and the UE determines, at a moment 2′, whether the limit is exceeded (for example, RX limit:=2). In this case, it is determined that the target limit is exceeded. Further, candidate resources for sending a PSSCH on at least a part of the carriers are discarded at a moment 3, so that expected receiving of the PSFCH does not exceed the corresponding limit.

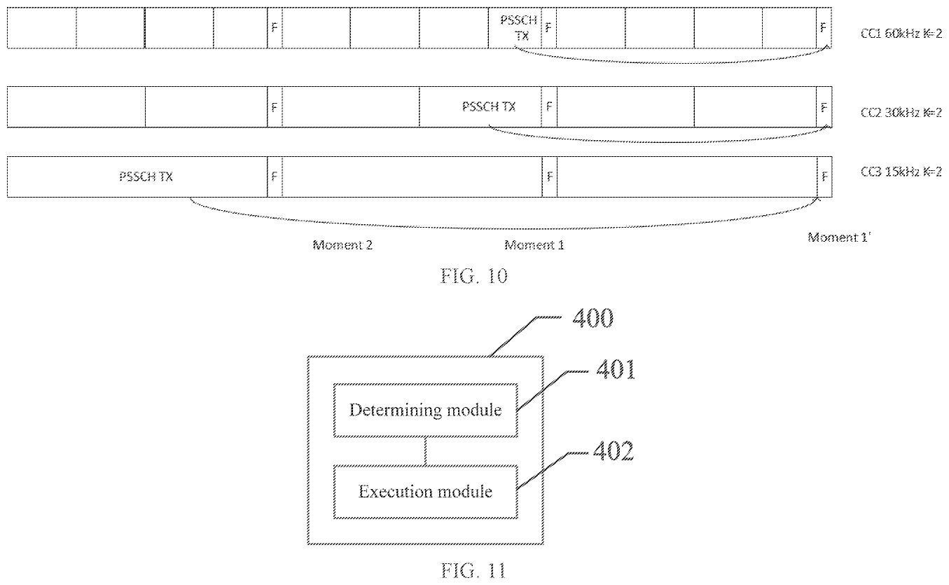

Scenario 2 As shown in FIG. 10, at a moment 1′, expected receiving of a PSFCH exists on three carriers, and the UE determines, at a moment 2′, whether the limit is exceeded (for example, RX limit:=2). In this case, it is determined that the target limit is exceeded. Further, expected receiving of the PSFCH on at least a part of the carriers is discarded at a moment 3, so that the corresponding limit is not exceeded.

In a possible example, the moment 1 and/or the moment 1′ are/is one or more time units (slots/symbols/subframes/frames/periods) corresponding to a preset SCS. For example, the preset SCS may be an SCS that includes a minimum or a maximum SCS in SCSs of carriers and/or CCs/BWPs/cells/resource pools including A.

In a possible example, for the moment 3, the moment 3:=the moment 2, or the moment 3 is after a moment 1 or a moment V of B.

In this embodiment of this application, the first UIE needs to ensure that transmission of the first UE does not exceed a transmission limit of the first UE, and the second UE ensures that transmission of the first UE does not exceed the limit of the first UE. For example, TX/RX resource selection is optimized. For example, when TX limit actual≥RX limit actual of UE 1, PSCCH/PSSCH TX resources are reasonably selected, so that a quantity of feedback PSFCHs that are expected to be received by the UE 1 at the same time does not exceed RX limit actual of the UE 1. For example, when TX limit actual≤RX limit actual of the UE 1, corresponding TX UE, that is, UE 2, needs to reasonably select TX resources, so that a quantity of feedbacks that need to be sent by the UE 1 does not exceed TX limit actual.

It should be noted that the first transmission object, the second transmission object, the third transmission object, the fourth transmission object, the fifth transmission object, and the sixth transmission object mentioned in this specification are all covered by the target transmission object.

In the transmission method provided in this embodiment of this application, a first device determines a target limit of first UE and drops first transmission in a case that transmission of a target transmission object that needs to be performed by the first UE exceeds the target limit, where the first transmission is at least a part of the transmission of the target transmission object, the target limit includes at least one of the following: a target transmission limit and a target time limit, and the transmission of the target transmission object is SL transmission. After the first device drops the first transmission, it can be ensured that the target limit is not exceeded when the first UE transmits the target transmission object, thereby ensuring that the first UE can normally perform SL transmission.

It should be noted that the transmission method provided in the embodiments of this application may be performed by a transmission apparatus, or a control module that is in the transmission apparatus and that is configured to perform the transmission method. In the embodiments of this application, an example in which the transmission apparatus performs the transmission method is used to describe the transmission apparatus provided in the embodiments of this application.

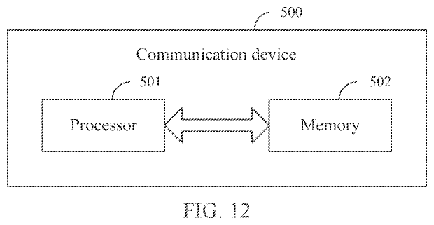

An embodiment of this application provides a transmission device. As shown in FIG. 11, a transmission apparatus 400 includes a determining module 401 and an execution module 402.

The determining module 401 is configured to determine a target limit of first UE; and the execution module 402 is configured to drop first transmission if transmission of a target transmission object that needs to be performed by the first UE exceeds the target limit determined by the determining module 401, where the first transmission is at least a part of the transmission of the target transmission object; the transmission of the target transmission object is SL, transmission; the target limit includes at least one of the following: a target transmission limit and a target time limit; the first device includes at least one of the following: the first UE, second UE, and a control node; and the second UE is UE related to sidelink transmission of the first UE.

In some embodiments, that transmission of a target transmission object that needs to be performed by the first UE exceeds the target limit includes: second transmission currently performed by the first UE does not exceed the target limit, and third transmission performed by the first UE exceeds the target limit, where the second transmission is at least a part of the transmission of the target transmission object; the third transmission is at least a part of the transmission of the target transmission object; and the third transmission includes any one of the following: the second transmission and additional transmission based on the second transmission; and transmission obtained by adjusting the second transmission.

In some embodiments, the dropping, by the first device, first transmission includes: in a case that a switching condition is met, dropping the first transmission and performing fourth transmission; and in a case that at least one of the switching condition is not met, dropping the first transmission.

In some embodiments, the switching condition includes at least one of the following:
the target transmission object meets the corresponding target time limit; and
a preset parameter associated with the target transmission object meets a preset condition.

In some embodiments, the target transmission object includes a first transmission object and/or a second transmission object, where a transmission manner corresponding to the first transmission object is sending, and a transmission manner corresponding to the second transmission object is receiving.

In some embodiments, if the target transmission object includes at least the first transmission object, the exceeding the target limit includes any one of the following:
the transmission corresponding to the first transmission object exceeds the corresponding target limit;
expected transmission associated with the first transmission object exceeds the corresponding target limit; and
the transmission corresponding to the first transmission object does not exceed the corresponding target limit, and the expected transmission associated with the first transmission object exceeds the corresponding target limit; where
the first transmission includes first sending and/or first expected transmission,
the first sending is a transmission corresponding to at least a part of the first transmission object; and
the first expected transmission is expected transmission associated with the transmission corresponding to at least a part of the first transmission object.

In some embodiments, the dropping first transmission includes at least one of the following:
performing dropping until the number of remaining first sending is not greater than a first predetermined quantity; and
performing dropping until the number of remaining first expected transmission is not greater than a second predetermined quantity.

In some embodiments, if the target transmission object includes at least the second transmission object, the exceeding the target limit includes any one of the following:
the receiving corresponding to the second transmission object exceeds the corresponding target limit;
expected transmission associated with the second transmission object exceeds the corresponding target limit; and
the receiving corresponding to the second transmission object does not exceed the corresponding target limit, and the expected transmission associated with the second transmission object exceeds the corresponding target limit, where
the first transmission includes first receiving and/or second expected transmission;
the first receiving is receiving corresponding to at least a part of the second transmission object; and
the second expected transmission is expected transmission associated with receiving corresponding to at least a part of the second transmission object.

In some embodiments, the dropping first transmission includes at least one of the following:
performing dropping until the number of remaining first receiving is not greater than a third predetermined quantity; and
performing dropping until the number of remaining second expected transmission is not greater than a fourth predetermined quantity.

In some embodiments, if the target transmission object includes the first transmission object and the second transmission object, the exceeding the target limit includes at least one of the following:
the transmission corresponding to the first transmission object and the receiving corresponding to the second transmission object exceed the corresponding target limit;
the transmission corresponding to the first transmission object and expected transmission associated with the second transmission object exceed the corresponding target limit;
expected transmission associated with the first transmission object and the expected transmission associated with the second transmission object exceed the corresponding target limit; and
the receiving corresponding to the second transmission object and the expected transmission associated with the first transmission object exceed the corresponding target limit, where
the first transmission includes at least one of the following:
second sending, third expected transmission, second receiving, and fourth expected transmission;
the second sending is a transmission corresponding to at least a part of the first transmission object;
the third expected transmission is expected transmission associated with the transmission corresponding to at least a part of the first transmission object;
the second receiving is receiving corresponding to at least a part of the second transmission object; and
the fourth expected transmission is expected transmission associated with receiving corresponding to at least a part of the second transmission object.

In some embodiments, the dropping first transmission includes at least one of the following:
performing dropping until the number of remaining fifth transmission is not greater than a fifth predetermined quantity;
performing dropping until the number of remaining sixth transmission is not greater than a sixth predetermined quantity; and
performing dropping until the number of remaining seventh transmission is not greater than a seventh predetermined quantity, where
the fifth transmission includes at least one of the following: first target transmission, second target transmission, and first target transmission and second target transmission; the sixth transmission includes at least one of the following: third target transmission, fourth target transmission, and third target transmission and fourth target transmission; and the seventh transmission includes at least one of the following: third target transmission, first target transmission, and third target transmission and first target transmission, where the first target transmission is the fourth expected transmission, the second target transmission is the third expected transmission, the third target transmission is the second sending, and the fourth target transmission is the second receiving, or the first target transmission is the third expected transmission, the second target transmission is the fourth expected transmission, the third target transmission is the second receiving, and the fourth target transmission is the second sending, or the first target transmission is the second receiving, the second target transmission is the third expected transmission, the third target transmission is the second sending, and the fourth target transmission is the fourth expected transmission; or the first target transmission is the fourth expected transmission, the second target transmission is the second sending, the third target transmission is the third expected transmission, and the fourth target transmission is the second receiving.

In some embodiments, the execution module 402 is configured to drop the first transmission according to a first predetermined rule, where
the first predetermined rule includes at least one of the following
according to a priority order of the target transmission object;
according to a priority order of a transmission type of the transmission of the target transmission object;
according to a priority order of the transmission of the target transmission object;
according to information about the target transmission object;
according to a frequency domain location of the transmission of the target transmission object;
according to a time domain location of the transmission of the target transmission object;
according to duration of the transmission of the target transmission object;
according to an SCS of the transmission of the target transmission object; and
according to content or a transmission object type of the transmission of the target transmission object.

In some embodiments, the information about the target transmission object includes at least one of the following:
coding of the target transmission object, an identifier of the target transmission object, and information about a target object associated with the target transmission object, where the target object includes at least one of the following an LCH, an LCG, QOS, a HARQ process, a TB, a data packet, and a PDU.

In some embodiments, the information about the target object associated with the target transmission object includes: a quantity of target objects and/or whether at least a part of same target objects is associated.

In some embodiments, the dropping first transmission according to information about a target object associated with the target transmission object includes: reserving target transmission objects on bearer objects associated with a same target object, and/or discarding target transmission objects on bearer objects associated with different target objects.

In some embodiments, the execution module 402 is further configured to: if transmission on a target bearer object exceeds the target limit, multiplex transmission on at least a part of bearer objects in the target bearer object to another bearer object in the target bearer object, where the at least a part of bearer objects in the target bearer object and the another bearer object are associated with a same target object.

In some embodiments, the target transmission object includes a third transmission object; and the execution module 402 is further configured to: determine, in a first time, whether transmission of the third transmission object within a second time exceeds the target transmission limit; and/or determine, in a third time, whether to drop the first transmission.

In some embodiments, the first time and/or the third time are/is before the second time, and/or duration of a time interval between the second time and the first time includes at least duration corresponding to at least one time limit in the target time limit; and/or duration of a time interval between the second time and the third time includes at least duration corresponding to at least one time limit in the target time limit.

In some embodiments, the execution module 402 is further configured to determine, in a fourth time, whether transmission of a fourth transmission object associated with the third transmission object exceeds the target transmission limit, where the transmission of the fourth transmission object is within a fifth time.

In some embodiments, there is a correspondence between a bearer object associated with the third transmission object and a bearer object associated with the fourth transmission object; and/or the bearer object associated with the third transmission object is at least partially the same as the bearer object associated with the fourth transmission object.

In some embodiments, the first time and/or the third time are/is before the second time, and/or duration of a time interval between the second time and the first time includes at least duration corresponding to at least one time limit in the target time limit; and/or duration of a time interval between the second time and the third time includes at least duration corresponding to at least one time limit in the target time limit; and/or the fourth time and/or the third time are/is before the fifth time; and/or duration of a time interval between the fifth time and the fourth time includes at least duration corresponding to at least one time limit in the target time limit, and/or duration of a time interval between the fifth time and the third time includes at least duration corresponding to at least one time limit in the target time limit.

In some embodiments, the determining, in a third time, whether to drop the first transmission includes at least one of the following: in a case that a first predetermined condition is met, determining, in the third time, whether to drop at least a part of transmission of the third transmission object; and in a case that a second predetermined condition is met, determining, in the third time, whether to drop at least a part of transmission of the fourth transmission object.

In some embodiments, the first predetermined condition includes at least one of the following: the first time and/or the third time are/is before the second time; duration of a time interval between the second time and the first time includes at least duration corresponding to at least one time limit in the target time limit; and duration of a time interval between the second time and the third time includes at least duration corresponding to at least one time limit in the target time limit; and the second predetermined condition includes at least one of the following: the fourth time and/or the third time are/is before the fifth time; duration of a time interval between the fifth time and the fourth time includes at least duration corresponding to at least one time limit in the target time limit, and duration of a time interval between the fifth time and the third time includes at least duration corresponding to at least one time limit in the target time limit.

In some embodiments, the target transmission limit includes at least one of the following: a quantity N1 of transmit antennas; a quantity N2 of receive antennas; a quantity N3 of transmit antennas and receive antennas; a quantity N4 of transmit chains; a quantity N5 of receive chains, a quantity N6 of transmit chains and receive chains; a maximum quantity of bearer objects for receiving and/or sending target transmission objects at the same time or within a first preset time; a maximum quantity of target transmission objects received and/or sent at the same time or within a second preset time; and a maximum quantity of target transmission objects received and/or sent at the same time or within a third preset time on X bearer objects, where X is a positive integer.

In some embodiments, the target time limit includes at least one of the following: a minimum time limit for switching a bearer object; a maximum time limit for switching a bearer object; a minimum time limit for power adjustment; a maximum time limit for power adjustment; a minimum time limit for adjusting a transmission chain, a maximum time limit for adjusting a transmission chain; a time limit for preparing the target transmission object; a time limit for preparing candidate resource reporting, and a time limit required for determining a candidate resource, where the transmission chain includes a transmit chain and/or a receive chain.

In some embodiments, the minimum time limit for adjusting a transmission chain includes at least one of the following: a time limit for transmission conversion; a minimum time limit for switching from sending to receiving; a minimum time limit for switching from receiving to sending, a minimum time limit for switching from sending to receiving and then to sending, and a minimum time limit for switching from receiving to sending and then to receiving; and the maximum time limit for adjusting a radio frequency chain includes at least one of the following: a time limit for radio frequency conversion; a maximum time limit for switching from sending to receiving; a maximum time limit for switching from receiving to sending; a maximum time limit for switching from sending to receiving and then to sending; and a maximum time limit for switching from receiving to sending and then to receiving.

In some embodiments, different target transmission objects respectively have corresponding target limits; and/or the target limit is related to a frequency domain.

In some embodiments, that the target limit is related to a frequency domain includes at least one of the following: transmission on a plurality of bearer objects at the same time or within a fourth preset time is supported only in a target frequency domain; and different frequency domains respectively have corresponding target limits.

In some embodiments, the target limit includes an actual limit and/or a first limit of the first UE, where the actual limit is determined based on the first limit.

In some embodiments, the first limit includes a first transmission limit, the actual limit includes an actual transmission limit; and the target transmission limit includes the first transmission limit and/or the actual transmission limit, where the first transmission limit includes at least one of the following: a first receive limit, a first transmit limit, and a first transmit and receive limit; and the actual transmission limit includes at least one of the following: an actual receive limit, an actual transmit limit, and an actual transmit and receive limit.

In some embodiments, the actual transmission limit includes at least one of the following: a quantity M1 of transmit antennas; a quantity M2 of receive antennas; a quantity M3 of transmit antennas and receive antennas; a quantity M4 of transmit chains; a quantity M5 of receive chains; a quantity M6 of transmit chains and receive chains, a maximum quantity of bearer objects for actually receiving and/or sending target transmission objects at the same time or within a first preset time; a maximum quantity of target transmission objects actually received and/or sent at the same time or within a second preset time; and a maximum quantity of target transmission objects actually received and/or sent at the same time or within a third preset time on N1 bearer objects.

In some embodiments, there is a first association relationship between the first receive limit and the first transmit limit; and/or there is a second association relationship between the actual transmit limit and any one of the following: the actual receive limit; the first transmit limit and the actual transmit limit; the first receive limit, and the first receive limit and the first transmit limit, and/or there is a third association relationship between the actual receive limit and any one of the following: the actual transmit limit; the first receive limit and the actual transmit limit; the first transmit limit; and the first receive limit and the first transmit limit, where the first association relationship is related to at least one of the following preset values: a first preset value corresponding to the first transmission limit; and a second preset value corresponding to the first transmission limit; the second association relationship is related to at least one of the following preset values: the first preset value corresponding to the first transmission limit, and a first preset value corresponding to the actual transmission limit; and the third association relationship is related to at least one of the following preset values: the second preset value corresponding to the first transmission limit; and a second preset value corresponding to the actual transmission limit, where the first preset value is less than or equal to a quantity of bearer objects that are expected to be received and that are corresponding to at least one time of sending on any bearer object or preset P bearer objects; and the second preset value is less than or equal to a quantity of bearer objects that are expected to be sent and that are corresponding to at least one time of receiving on any bearer object or preset Q bearer objects. In some embodiments, the actual transmission limit is determined based on the first transmission limit and a second predetermined rule, where the second predetermined rule includes at least one of the following: at least one of the actual transmission limit is less than or equal to a first value; at least one of the actual transmission limit is equal to a second value; and at least one of the actual transmission limit is equal to a third value, where the first value is a minimum value in the first transmit limit and the first receive limit, the second value is determined based on the first transmit limit and the first receive limit, and the third value is determined based on the first transmit and receive limit.

In some embodiments, the target limit is determined based on at least one of the following: a UE capability of the first UE; a transmission limit configured by the control node, a transmission limit indicated by another UE; being preconfigured; and being predefined in a protocol.

In some embodiments, when the first device selects or reports a target resource of the target transmission object, or another UE indicates the target resource, or the control node configures or schedules the target resource, the transmission of the target transmission object does not exceed the target limit, where
the target resource includes at least one of the following: a candidate resource; and a resource used for actual transmission.

In the transmission apparatus provided in this embodiment of this application, the apparatus determines a target limit of first UE and drops first transmission in a case that transmission of a target transmission object that needs to be performed by the first UE exceeds the target limit, where the first transmission is at least a part of the transmission of the target transmission object, the target limit includes at least one of the following: a target transmission limit and a target time limit, and the transmission of the target transmission object is SL transmission. After the first device drops the first transmission, it can be ensured that the target limit is not exceeded when the first UE transmits the target transmission object, thereby ensuring that the first UE can normally perform SL transmission.

The transmission apparatus in this embodiment of this application may be an apparatus, an apparatus or an electronic device with an operating system, or may be a component, an integrated circuit, or a chip in a terminal. The apparatus or the electronic device may be a mobile terminal, or a non-mobile terminal. For example, the mobile device may include but is not limited to the types of the terminal 11 listed above, and the non-mobile terminal may be a server, a Network Attached Storage (NAS), a Personal Computer (PC), a Television (TV), an automated teller machine, or a self-service machine. This is not specifically limited in the embodiments of this application.

The transmission apparatus provided in this embodiment of this application can implement the processes implemented in the foregoing method embodiment, and achieve a same technical effect. To avoid repetition, details are not described herein again.

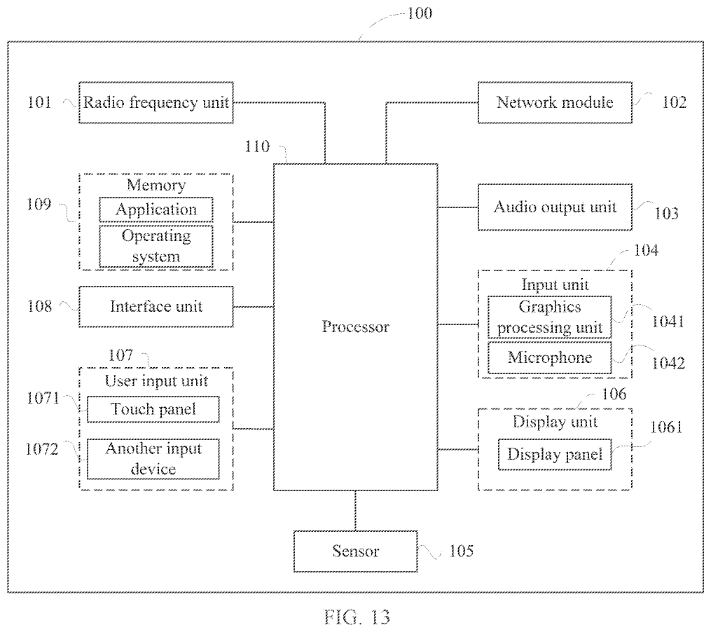

For example, as shown in FIG. 12, an embodiment of this application further provides a communication device (which may also be referred to as a transmission device) 500, including a processor 501, a memory 502, and a program or an instruction that is stored in the memory 502 and that can be run on the processor 501. For example, when the communication device 500 is UE, the program or the instruction is executed by the processor 501 to implement the processes implemented by the UE in the method embodiment of the foregoing transmission method, and a same technical effect can be achieved.

An embodiment of this application further provides a transmission device. The transmission device is a first device, including a processor and a communication interface, where the processor is configured to: determine a target limit of first UE, and drop, by the first device, first transmission if transmission of a target transmission object that needs to be performed by the first UE exceeds the target limit, where the first transmission is at least a part of the transmission of the target transmission object; the transmission of the target transmission object is SL transmission; the target limit includes at least one of the following, a target transmission limit and a target time limit, the first device includes at least one of the following: the first UE and second UE; and the second UE is UE related to sidelink transmission of the first UE. The embodiment of the first device corresponds to the foregoing method embodiment Each implementation process and implementation of the foregoing method embodiment may be applicable to this terminal embodiment, and a same technical effect can be achieved.

For example, FIG. 13 is a schematic structural diagram of hardware of UE according to an embodiment of this application. The UE 100 includes but is not limited to at least a part of components such as a radio frequency unit 101, a network module 102, an audio output unit 103, an input unit 104, a sensor 105, a display unit 106, a user input unit 107, an interface unit 108, a memory 109, and a processor 110.

A person skilled in the art can understand that the UE 100 may further include a power supply (such as a battery) that supplies power to each component. The power supply may be logically connected to the processor 110 by using a power supply management system, to implement functions such as charging and discharging management, and power consumption management by using the power supply management system. The structure of the UE shown in FIG. 13 constitutes no limitation on the UE, and the UE may include more or fewer components than those shown in the figure, or combine some components, or have different component arrangements Details are not described herein.

It should be understood that, in this embodiment of this application, the input unit 104 may include a Graphics Processing Unit (GPU) 1041 and a microphone 1042, and the graphics processing unit 1041 processes image data of a still picture or a video obtained by an image capture apparatus (such as a camera) in a video capture mode or an image capture mode. The display unit 106 may include a display panel 1061. In some embodiments, the display panel 1061 may be configured in a form such as a liquid crystal display or an organic light-emitting diode. The user input unit 107 includes a touch panel 1071 and another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

In this embodiment of this application, the radio frequency unit 101 receives downlink data from a network side device and then sends the downlink data to the processor 110 for processing; and sends uplink data to the network side device. Usually, the radio frequency unit 101 includes but is not limited to an antenna, at least one amplifier, a transceiver, a coupler, a low noise amplifier, a duplexer, and the like.

The memory 109 may be configured to store a software program or an instruction and various data. The memory 109 may mainly include a program or instruction storage area and a data storage area. The program or instruction storage area may store an operating system, and an application or an instruction required by at least one function (for example, a sound playing function or an image playing function). In addition, the memory 109 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk storage component, a flash memory component, or another non-volatile solid-state storage component.

The processor 110 may include one or more processing units. In some embodiments, an application processor and a modem processor may be integrated into the processor 110. The application processor mainly processes an operating system, a user interface, an application, an instruction, or the like. The modem processor mainly processes wireless communication, for example, a baseband processor. It can be understood that the modem processor may not be integrated into the processor 110.

The processor 110 is configured to: determine a target limit of first UE; and drop, by the first device, first transmission if transmission of a target transmission object that needs to be performed by the first UE exceeds the target limit, where the first transmission is at least a part of the transmission of the target transmission object; the transmission of the target transmission object is SL transmission; the target limit includes at least one of the following: a target transmission limit and a target time limit, the first device includes at least one of the following: the first UE and second UE; and the second UE is UE related to sidelink transmission of the first UE.

In some embodiments, that transmission of a target transmission object that needs to be performed by the first UE exceeds the target limit includes: second transmission currently performed by the first UE does not exceed the target limit, and third transmission performed by the first UE exceeds the target limit, where the second transmission is at least a part of the transmission of the target transmission object; the third transmission is at least a part of the transmission of the target transmission object; and the third transmission includes any one of the following: the second transmission and additional transmission based on the second transmission; and transmission obtained by adjusting the second transmission.

In some embodiments, the dropping, by the first device, first transmission includes: in a case that a switching condition is met, dropping the first transmission and performing fourth transmission; and in a case that at least one of the switching condition is not met, dropping the first transmission.

In some embodiments, the switching condition includes at least one of the following: the target transmission object meets the corresponding target time limit; and a preset parameter associated with the target transmission object meets a preset condition.

In some embodiments, the target transmission object includes a first transmission object and/or a second transmission object, where a transmission manner corresponding to the first transmission object is sending, and a transmission manner corresponding to the second transmission object is receiving.

In some embodiments, if the target transmission object includes at least the first transmission object, the exceeding the target limit includes any one of the following:
the transmission corresponding to the first transmission object exceeds the corresponding target limit;
expected transmission associated with the first transmission object exceeds the corresponding target limit; and
the transmission corresponding to the first transmission object does not exceed the corresponding target limit, and the expected transmission associated with the first transmission object exceeds the corresponding target limit, where
the first transmission includes first sending and/or first expected transmission;
the first sending is a transmission corresponding to at least a part of the first transmission object; and
the first expected transmission is expected transmission associated with the transmission corresponding to at least a part of the first transmission object.

In some embodiments, the dropping first transmission includes at least one of the following:
performing dropping until the number of remaining first sending is not greater than a first predetermined quantity; and
performing dropping until the number of first expected transmission is not greater than a second predetermined quantity.

In some embodiments, if the target transmission object includes at least the second transmission object, the exceeding the target limit includes any one of the following:
the receiving corresponding to the second transmission object exceeds the corresponding target limit;
expected transmission associated with the second transmission object exceeds the corresponding target limit; and
the receiving corresponding to the second transmission object does not exceed the corresponding target limit, and the expected transmission associated with the second transmission object exceeds the corresponding target limit, where
the first transmission includes first receiving and/or second expected transmission;
the first receiving is receiving corresponding to at least a part of the second transmission object; and
the second expected transmission is expected transmission associated with receiving corresponding to at least a part of the second transmission object.

In some embodiments, the dropping first transmission includes at least one of the following:
performing dropping until the number of remaining first receiving is not greater than a third predetermined quantity; and
performing dropping until the number of remaining second expected transmission is not greater than a fourth predetermined quantity.

In some embodiments, if the target transmission object includes the first transmission object and the second transmission object, the exceeding the target limit includes at least one of the following:
the transmission corresponding to the first transmission object and the receiving corresponding to the second transmission object exceed the corresponding target limit;
the transmission corresponding to the first transmission object and expected transmission associated with the second transmission object exceed the corresponding target limit;
expected transmission associated with the first transmission object and the expected transmission associated with the second transmission object exceed the corresponding target limit; and
the receiving corresponding to the second transmission object and the expected transmission associated with the first transmission object exceed the corresponding target limit, where
the first transmission includes at least one of the following:
second sending, third expected transmission, second receiving, and fourth expected transmission;
the second sending is a transmission corresponding to at least a part of the first transmission object;
the third expected transmission is expected transmission associated with the transmission corresponding to at least a part of the first transmission object,
the second receiving is receiving corresponding to at least a part of the second transmission object; and
the fourth expected transmission is expected transmission associated with receiving corresponding to at least a part of the second transmission object.

In some embodiments, the dropping first transmission includes at least one of the following:
performing dropping until the number of remaining fifth transmission is not greater than a fifth predetermined quantity;
performing dropping until the number of remaining sixth transmission is not greater than a sixth predetermined quantity; and
performing dropping until the number of remaining seventh transmission is not greater than a seventh predetermined quantity, where
the fifth transmission includes at least one of the following: first target transmission, second target transmission, and first target transmission and second target transmission; the sixth transmission includes at least one of the following: third target transmission, fourth target transmission, and third target transmission and fourth target transmission; and the seventh transmission includes at least one of the following: third target transmission, first target transmission, and third target transmission and first target transmission, where the first target transmission is the fourth expected transmission, the second target transmission is the third expected transmission, the third target transmission is the second sending, and the fourth target transmission is the second receiving; or the first target transmission is the third expected transmission, the second target transmission is the fourth expected transmission, the third target transmission is the second receiving, and the fourth target transmission is the second sending; or the first target transmission is the second receiving, the second target transmission is the third expected transmission, the third target transmission is the second sending, and the fourth target transmission is the fourth expected transmission, or the first target transmission is the fourth expected transmission, the second target transmission is the second sending, the third target transmission is the third expected transmission, and the fourth target transmission is the second receiving.

In some embodiments, the processor 110 is configured to drop the first transmission according to a first predetermined rule, where
the first predetermined rule includes at least one of the following:
according to a priority order of the target transmission object;
according to a priority order of a transmission type of the transmission of the target transmission object,
according to a priority order of the transmission of the target transmission object;
according to information about the target transmission object;
according to a frequency domain location of the transmission of the target transmission object;
according to a time domain location of the transmission of the target transmission object;
according to duration of the transmission of the target transmission object;
according to an SCS of the transmission of the target transmission object; and
   according to content or a transmission object type of the transmission of the target transmission object.

In some embodiments, the information about the target transmission object includes at least one of the following:
coding of the target transmission object, an identifier of the target transmission object, and information about a target object associated with the target transmission object, where the target object includes at least one of the following an LCH, an LCG, QOS, a HARQ process, a TB, a data packet, and a PDU.

In some embodiments, the information about the target object associated with the target transmission object includes a quantity of target objects and/or whether at least a part of same target objects are associated.

In some embodiments, the dropping first transmission according to information about a target object associated with the target transmission object includes: reserving target transmission objects on bearer objects associated with a same target object, and/or discarding target transmission objects on bearer objects associated with different target objects.

In some embodiments, the processor 110 is further configured to: if transmission on a target bearer object exceeds the target limit, multiplex transmission on at least a part of bearer objects in the target bearer object to another bearer object in the target bearer object, where the at least a part of bearer objects in the target bearer object and the another bearer object are associated with a same target object.

In some embodiments, the target transmission object includes a third transmission object; and the processor 110 is further configured to: determine, in a first time, whether transmission of the third transmission object within a second time exceeds the target transmission limit; and/or determine, in a third time, whether to drop the first transmission.

In some embodiments, the first time and/or the third time are/is before the second time; and/or duration of a time interval between the second time and the first time includes at least duration corresponding to at least one time limit in the target time limit; and/or duration of a time interval between the second time and the third time includes at least duration corresponding to at least one time limit in the target time limit.

In some embodiments, the processor 110 is further configured to determine, in a fourth time, whether transmission of a fourth transmission object associated with the third transmission object exceeds the target transmission limit, where the transmission of the fourth transmission object is within a fifth time.

In some embodiments, there is a correspondence between a bearer object associated with the third transmission object and a bearer object associated with the fourth transmission object; and/or the bearer object associated with the third transmission object is at least partially the same as the bearer object associated with the fourth transmission object.

In some embodiments, the first time and/or the third time are/is before the second time; and/or duration of a time interval between the second time and the first time includes at least duration corresponding to at least one time limit in the target time limit, and/or duration of a time interval between the second time and the third time includes at least duration corresponding to at least one time limit in the target time limit; and/or the fourth time and/or the third time are/is before the fifth time, and/or duration of a time interval between the fifth time and the fourth time includes at least duration corresponding to at least one time limit in the target time limit; and/or duration of a time interval between the fifth time and the third time includes at least duration corresponding to at least one time limit in the target time limit.

In some embodiments, the determining, in a third time, whether to drop the first transmission includes at least one of the following:
in a case that a first predetermined condition is met, determining, in the third time, whether to drop at least a part of transmission of the third transmission object; and
in a case that a second predetermined condition is met, determining, in the third time, whether to drop at least a part of transmission of the fourth transmission object.

In some embodiments, the first predetermined condition includes at least one of the following: the first time and/or the third time are/is before the second time; duration of a time interval between the second time and the first time includes at least duration corresponding to at least one time limit in the target time limit; and duration of a time interval between the second time and the third time includes at least duration corresponding to at least one time limit in the target time limit; and the second predetermined condition includes at least one of the following: the fourth time and/or the third time are/is before the fifth time; duration of a time interval between the fifth time and the fourth time includes at least duration corresponding to at least one time limit in the target time limit, and duration of a time interval between the fifth time and the third time includes at least duration corresponding to at least one time limit in the target time limit.

In some embodiments, the target transmission limit includes at least one of the following, a quantity N1 of transmit antennas, a quantity N2 of receive antennas; a quantity N3 of transmit antennas and receive antennas; a quantity N4 of transmit chains; a quantity N5 of receive chains, a quantity N6 of transmit chains and receive chains; a maximum quantity of bearer objects for receiving and/or sending target transmission objects at the same time or within a first preset time; a maximum quantity of target transmission objects received and/or sent at the same time or within a second preset time; and a maximum quantity of target transmission objects received and/or sent at the same time or within a third preset time on X bearer objects, where X is a positive integer.

In some embodiments, the target time limit includes at least one of the following: a minimum time limit for switching a bearer object: a maximum time limit for switching a bearer object; a minimum time limit for power adjustment; a maximum time limit for power adjustment; a minimum time limit for adjusting a transmission chain; a maximum time limit for adjusting a transmission chain; a time limit for preparing the target transmission object; a time limit for preparing candidate resource reporting; and a time limit required for determining a candidate resource, where the transmission chain includes a transmit chain and/or a receive chain.

In some embodiments, the minimum time limit for adjusting a transmission chain includes at least one of the following: a time limit for transmission conversion; a minimum time limit for switching from sending to receiving; a minimum time limit for switching from receiving to sending; a minimum time limit for switching from sending to receiving and then to sending; and a minimum time limit for switching from receiving to sending and then to receiving, and the maximum time limit for adjusting a radio frequency chain includes at least one of the following: a time limit for radio frequency conversion; a maximum time limit for switching from sending to receiving; a maximum time limit for switching from receiving to sending; a maximum time limit for switching from sending to receiving and then to sending; and a maximum time limit for switching from receiving to sending and then to receiving.

In some embodiments, different target transmission objects respectively have corresponding target limits; and/or the target limit is related to a frequency domain.

In some embodiments, that the target limit is related to a frequency domain includes at least one of the following: transmission on a plurality of bearer objects at the same time or within a fourth preset time is supported only in a target frequency domain; and different frequency domains respectively have corresponding target limits.

In some embodiments, the target limit includes an actual limit and/or a first limit of the first UE, where the actual limit is determined based on the first limit.

In some embodiments, the first limit includes a first transmission limit, the actual limit includes an actual transmission limit; and the target transmission limit includes the first transmission limit and/or the actual transmission limit, where the first transmission limit includes at least one of the following: a first receive limit, a first transmit limit, and a first transmit and receive limit; and the actual transmission limit includes at least one of the following: an actual receive limit, an actual transmit limit, and an actual transmit and receive limit.

In some embodiments, the actual transmission limit includes at least one of the following: a quantity M1 of transmit antennas; a quantity M2 of receive antennas; a quantity M3 of transmit antennas and receive antennas, a quantity M4 of transmit chains; a quantity M5 of receive chains; a quantity M6 of transmit chains and receive chains; a maximum quantity of bearer objects for actually receiving and/or sending target transmission objects at the same time or within a first preset time; a maximum quantity of target transmission objects actually received and/or sent at the same time or within a second preset time; and a maximum quantity of target transmission objects actually received and/or sent at the same time or within a third preset time on N1 bearer objects.

In some embodiments, there is a first association relationship between the first receive limit and the first transmit limit; and/or there is a second association relationship between the actual transmit limit and any one of the following: the actual receive limit, the first transmit limit and the actual transmit limit; the first receive limit; and the first receive limit and the first transmit limit; and/or there is a third association relationship between the actual receive limit and any one of the following: the actual transmit limit; the first receive limit and the actual transmit limit; the first transmit limit; and the first receive limit and the first transmit limit, where the first association relationship is related to at least one of the following preset values: a first preset value corresponding to the first transmission limit; and a second preset value corresponding to the first transmission limit; the second association relationship is related to at least one of the following preset values: the first preset value corresponding to the first transmission limit, and a first preset value corresponding to the actual transmission limit; and the third association relationship is related to at least one of the following preset values: the second preset value corresponding to the first transmission limit, and a second preset value corresponding to the actual transmission limit, where the first preset value is less than or equal to a quantity of bearer objects that are expected to be received and that are corresponding to at least one time of sending on any bearer object or preset P bearer objects, and the second preset value is less than or equal to a quantity of bearer objects that are expected to be sent and that are corresponding to at least one time of receiving on any bearer object or preset Q bearer objects.

In some embodiments, the actual transmission limit is determined based on the first transmission limit and a second predetermined rule, where
the second predetermined rule includes at least one of the following: at least one of the actual transmission limit is less than or equal to a first value, at least one of the actual transmission limit is equal to a second value, and at least one of the actual transmission limit is equal to a third value, where the first value is a minimum value in the first transmit limit and the first receive limit; the second value is determined based on the first transmit limit and the first receive limit; and the third value is determined based on the first transmit and receive limit.

In some embodiments, the target limit is determined based on at least one of the following: a UE capability of the first UE; a transmission limit configured by the control node, a transmission limit indicated by another UE; being preconfigured; and being predefined in a protocol.

In some embodiments, when the first device selects or reports a target resource of the target transmission object, or another UE indicates the target resource, or the control node configures or schedules the target resource, the transmission of the target transmission object does not exceed the target limit, where
the target resource includes at least one of the following, a candidate resource; and a resource used for actual transmission.

In the UE provided in this embodiment of this application, the UIE determines a target limit of first UE and drops first transmission in a case that transmission of a target transmission object that needs to be performed by the first UIE exceeds the target limit, where the first transmission is at least a part of the transmission of the target transmission object, the target limit includes at least one of the following: a target transmission limit and a target time limit, and the transmission of the target transmission object is SL transmission. After the first device drops the first transmission, it can be ensured that the target limit is not exceeded when the first UE transmits the target transmission object, thereby ensuring that the first UE can normally perform SL transmission.

An embodiment of this application further provides a readable storage medium. The readable storage medium stores a program or an instruction, and when the program or the instruction is executed by a processor, the processes of the method embodiment of the foregoing transmission method are implemented and a same technical effect can be achieved. To avoid repetition, details are not described herein again.

The processor is a processor in the terminal in the foregoing embodiment. The readable storage medium includes a computer-readable storage medium, such as a computer ROM, a Random Access Memory (RAM), a magnetic disk, or an optical disc.

An embodiment of this application further provides a chip. The chip includes a processor and a communication interface, the communication interface is coupled to the processor, and the processor is configured to run a program or an instruction to implement the processes of the method embodiment of the foregoing transmission method, and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “including a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In some embodiments, the technical solutions of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, an air conditioner, a network side device, or the like) to perform the methods described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. A transmission method, comprising:
determining, by a first device, a target limit of a first User Equipment (UE); and
dropping, by the first device, first transmission when transmission of a target transmission object that needs to be performed by the first UE exceeds the target limit,
wherein:
the first transmission is at least a part of the transmission of the target transmission object;
the transmission of the target transmission object is Sidelink (SL) transmission;
the target limit comprises at least one of the following, a target transmission limit or a target time limit;
the first device comprises at least one of the following: the first UE, a second UE, or a control node; and
the second UE is a UE related to sidelink transmission of the first UE.

2. The transmission method according to claim 1, wherein that transmission of a target transmission object that needs to be performed by the first UE exceeds the target limit comprises:
second transmission currently performed by the first UE does not exceed the target limit, and third transmission performed by the first UE exceeds the target limit,
wherein:
the second transmission is at least a part of the transmission of the target transmission object;
the third transmission is at least a part of the transmission of the target transmission object; and
the third transmission comprises any one of the following:
the second transmission and additional transmission based on the second transmission, or transmission obtained by adjusting the second transmission.

3. The transmission method according to claim 1, wherein the dropping, by the first device, first transmission comprises:
when a switching condition is met, dropping the first transmission and performing fourth transmission; and
when at least one of the switching condition is not met, dropping the first transmission, wherein the switching condition comprises at least one of the following:
that the target transmission object meets the corresponding target time limit; or
that a preset parameter associated with the target transmission object meets a preset condition.

4. The transmission method according to claim 1, wherein the target transmission object comprises a first transmission object or a second transmission object, wherein a transmission manner corresponding to the first transmission object is sending, and a transmission manner corresponding to the second transmission object is receiving,
wherein:
when the target transmission object comprises at least the first transmission object, the exceeding the target limit comprises one of the following:
the transmission corresponding to the first transmission object exceeds the corresponding target limit;
expected transmission associated with the first transmission object exceeds the corresponding target limit; or
the transmission corresponding to the first transmission object does not exceed the corresponding target limit, and the expected transmission associated with the first transmission object exceeds the corresponding target limit,
wherein: the first transmission comprises first sending or first expected transmission, the first sending is a transmission corresponding to at least a part of the first transmission object, and the first expected transmission is expected transmission associated with the transmission corresponding to at least a part of the first transmission object;
when the target transmission object comprises at least the second transmission object, the exceeding the target limit comprises one of the following:
the reception corresponding to the second transmission object exceeds the corresponding target limit;
expected transmission associated with the second transmission object exceeds the corresponding target limit; or
the reception corresponding to the second transmission object does not exceed the corresponding target limit, and the expected transmission associated with the second transmission object exceeds the corresponding target limit,
wherein: the first transmission comprises first reception or second expected transmission, the first reception is a reception corresponding to at least a part of the second transmission object, and the second expected transmission is expected transmission associated with the reception corresponding to at least a part of the second transmission object,
when the target transmission object comprises the first transmission object and the second transmission object, the exceeding the target limit comprises at least one of the following:
the transmission corresponding to the first transmission object and the receiving corresponding to the second transmission object exceed the corresponding target limit;
the transmission corresponding to the first transmission object and expected transmission associated with the second transmission object exceed the corresponding target limit;
expected transmission associated with the first transmission object and the expected transmission associated with the second transmission object exceed the corresponding target limit; or
the receiving corresponding to the second transmission object and the expected transmission associated with the first transmission object exceed the corresponding target limit, wherein the first transmission comprises at least one of the following:
second sending, third expected transmission, second receiving, or fourth expected transmission, wherein:
the second sending is a transmission corresponding to at least a part of the first transmission object;
the third expected transmission is expected transmission associated with the transmission corresponding to at least a part of the first transmission object;
the second receiving is receiving corresponding to at least a part of the second transmission object; and
the fourth expected transmission is expected transmission associated with receiving corresponding to at least a part of the second transmission object.

5. The transmission method according to claim 4, wherein
the dropping first transmission comprises at least one of the following:
performing dropping until the number of remaining first sending is not greater than a first predetermined quantity;
performing dropping until the number of remaining first expected transmission is not greater than a second predetermined quantity;
performing dropping until the number of the remaining first reception is not greater than a third predetermined quantity;
performing dropping until the number of the remaining second expected transmission is not greater than a fourth predetermined quantity;
performing dropping until the number of remaining fifth transmission is not greater than a fifth predetermined quantity;
performing dropping until the number of remaining sixth transmission is not greater than a sixth predetermined quantity; or
performing dropping until the number of remaining seventh transmission is not greater than a seventh predetermined quantity;
wherein:
the fifth transmission comprises at least one of the following: first target transmission, second target transmission, or first target transmission and second target transmission;
the sixth transmission comprises at least one of the following: third target transmission, fourth target transmission, or third target transmission and fourth target transmission; and
the seventh transmission comprises at least one of the following: third target transmission, first target transmission, or third target transmission and first target transmission,
wherein:
the first target transmission is the fourth expected transmission, the second target transmission is the third expected transmission, the third target transmission is the second sending, and the fourth target transmission is the second receiving; or
the first target transmission is the third expected transmission, the second target transmission is the fourth expected transmission, the third target transmission is the second receiving, and the fourth target transmission is the second sending; or
the first target transmission is the second receiving, the second target transmission is the third expected transmission, the third target transmission is the second sending, and the fourth target transmission is the fourth expected transmission; or
the first target transmission is the fourth expected transmission, the second target transmission is the second sending, the third target transmission is the third expected transmission, and the fourth target transmission is the second receiving.

6. The transmission method according to claim 1, wherein the dropping first transmission comprises:
dropping the first transmission according to a first predetermined rule, wherein
the first predetermined rule comprises at least one of the following:
according to a priority order of the target transmission object;
according to a priority order of a transmission type of the transmission of the target transmission object;
according to a priority order of the transmission of the target transmission object;
according to information about the target transmission object;
according to a frequency domain location of the transmission of the target transmission object;
according to a time domain location of the transmission of the target transmission object;
according to duration of the transmission of the target transmission object;
according to a Subcarrier Spacing (SCS) of the transmission of the target transmission object; or
according to content or a transmission object type of the transmission of the target transmission object.

7. The transmission method according to claim 6, wherein the information about the target transmission object comprises at least one of the following:
coding of the target transmission object, an identifier of the target transmission object, or information about a target object associated with the target transmission object, wherein
the target object comprises at least one of the following:
a Logical Channel (LCH), a Logical Channel Group (LCG), Quality of Service (QOS), a HARQ process, a Transport Block (TB), a data packet, or a Protocol Data Unit (PDU).

8. The transmission method according to claim 7, wherein the information about the target object associated with the target transmission object comprises: a quantity of target objects or whether at least a part of same target objects are associated.

9. The transmission method according to claim 7, wherein the dropping first transmission according to information about a target object associated with the target transmission object comprises:
reserving target transmission objects on bearer objects associated with a same target object, or dropping target transmission objects on bearer objects associated with different target objects.

10. The transmission method according to claim 1, wherein when transmission on a target bearer object exceeds the target limit, the method further comprises:
multiplexing transmission on at least a part of bearer objects in the target bearer object to another bearer object in the target bearer object, wherein
the at least a part of bearer objects in the target bearer object and the another bearer object are associated with a same target object.

11. The transmission method according to claim 1, wherein
the target transmission object comprises a third transmission object; and
before the dropping, by the first device, first transmission, the method further comprises:
determining, in a first time, whether transmission of the third transmission object within a second time exceeds the target transmission limit; or
determining, in a third time, whether to drop the first transmission,
wherein:
the first time or the third time is before the second time, or
duration of a time interval between the second time and the first time comprises at least duration corresponding to at least one time limit in the target time limit, or
duration of a time interval between the second time and the third time comprises at least duration corresponding to at least one time limit in the target time limit.

12. The transmission method according to claim 11, wherein before the dropping, by the first device, first transmission, the method further comprises:
determining, in a fourth time, whether transmission of a fourth transmission object associated with the third transmission object exceeds the target transmission limit, wherein the transmission of the fourth transmission object is within a fifth time.

13. The transmission method according to claim 12, wherein
the fourth time or the third time is before the fifth time, or
duration of a time interval between the fifth time and the fourth time comprises at least duration corresponding to at least one time limit in the target time limit, or
duration of a time interval between the fifth time and the third time comprises at least duration corresponding to at least one time limit in the target time limit.

14. The transmission method according to claim 12, wherein the determining, in a third time, whether to drop the first transmission comprises at least one of the following:
when a first predetermined condition is met, determining, in the third time, whether to drop at least a part of transmission of the third transmission object; and
when a second predetermined condition is met, determining, in the third time, whether to drop at least a part of transmission of the fourth transmission object,
wherein:
the first predetermined condition comprises at least one of the following:
the first time or the third time is before the second time,
duration of a time interval between the second time and the first time comprises at least duration corresponding to at least one time limit in the target time limit, or
duration of a time interval between the second time and the third time comprises at least duration corresponding to at least one time limit in the target time limit; and
the second predetermined condition comprises at least one of the following:
the fourth time or the third time is before the fifth time;
duration of a time interval between the fifth time and the fourth time comprises at least duration corresponding to at least one time limit in the target time limit, or
duration of a time interval between the fifth time and the third time comprises at least duration corresponding to at least one time limit in the target time limit.

15. The transmission method according to claim 1, wherein the target transmission limit comprises at least one of the following:
a quantity N1 of transmit antennas;
a quantity N2 of receive antennas;
a quantity N3 of transmit antennas and receive antennas;
a quantity N4 of transmit chains;
a quantity N5 of receive chains;
a quantity N6 of transmit chains and receive chains;
a maximum quantity of bearer objects for receiving or sending target transmission objects at the same time or within a first preset time;
a maximum quantity of target transmission objects received or sent at the same time or within a second preset time; or
a maximum quantity of target transmission objects received or sent at the same time or within a third preset time on X bearer objects, wherein X is a positive integer.

16. The transmission method according to claim 1, wherein the target time limit comprises at least one of the following:
a minimum time limit for switching a bearer object;
a maximum time limit for switching a bearer object;
a minimum time limit for power adjustment;
a maximum time limit for power adjustment;
a minimum time limit for adjusting a transmission chain;
a maximum time limit for adjusting a transmission chain;
a time limit for preparing the target transmission object;
a time limit for preparing candidate resource reporting; or
a time limit required for determining a candidate resource, wherein the transmission chain comprises a transmit chain or a receive chain.

17. The transmission method according to claim 1, wherein
transmission on a plurality of bearer objects at the same time or within a fourth preset time is supported only in a target frequency domain, and
different frequency domains respectively have corresponding target limits.

18. The transmission method according to claim 1, wherein the target limit comprises an actual limit or a first limit of the first UE, wherein the actual limit is determined based on the first limit, wherein
the first limit comprises a first transmission limit;
the actual limit comprises an actual transmission limit; and
the target transmission limit comprises the first transmission limit or the actual transmission limit, wherein:
the first transmission limit comprises at least one of the following a first receive limit, a first transmit limit, or a first transmit and receive limit; and
the actual transmission limit comprises at least one of the following, an actual receive limit, an actual transmit limit, or an actual transmit and receive limit.

19. A transmission device, comprising a processor; and a memory having a computer program or an instruction stored thereon, wherein the computer program or the instruction, when executed by the processor, causes to implement operations comprising:
determining a target limit of a first User Equipment (UE); and
dropping first transmission when transmission of a target transmission object that needs to be performed by the first UE exceeds the target limit,
wherein:
the first transmission is at least a part of the transmission of the target transmission object;
the transmission of the target transmission object is Sidelink (SL) transmission;
the target limit comprises at least one of the following: a target transmission limit or a target time limit;
the transmission device comprises at least one of the following the first UE, a second UE, or a control node; and
the second UE is a UE related to sidelink transmission of the first UE.

20. A non-transitory computer readable storage medium storing a computer program or an instruction that, when executed by a processor, causes the processor to implement operations comprising:
determining a target limit of a first User Equipment (UE); and
dropping first transmission when transmission of a target transmission object that needs to be performed by the first UE exceeds the target limit,
wherein:
the first transmission is at least a part of the transmission of the target transmission object;
the transmission of the target transmission object is Sidelink (SL) transmission; and
the target limit comprises at least one of the following: a target transmission limit or a target time limit.
